(19) United States
(12) Patent Application Publication
(10) Pub. No.: US 2011/0074870 A1
(43) Pub. Date: Mar. 31, 2011

(54) LIQUID EJECTION HEAD CLEANING APPARATUS AND IMAGE RECORDING APARATUS

(76) Inventor: Noriaki MAIDA, Kanagawa-ken (JP)

(21) Appl. No.: 12/893,144

(22) Filed: Sep. 29, 2010

(30) Foreign Application Priority Data
Sep. 30, 2009 (JP) 2009-227340
Sep. 30, 2009 (JP) 2009-228225

(51) Int. Cl. B41J 2/165; B08B 9/00

(52) U.S. Cl. 347/28; 134/166 R

(57) ABSTRACT

The liquid ejection head cleaning apparatus includes: a cleaning liquid deposition device which spouts cleaning liquid from a plurality of cleaning liquid nozzles and deposits the cleaning liquid onto an ejection surface of a liquid ejection head; a cleaning liquid supply device which supplies the cleaning liquid to the cleaning liquid nozzles by using a liquid head differential with respect to the cleaning liquid deposition device; a temperature measurement device which measures an ambient temperature around the cleaning liquid supply device; and a pressure control device which controls a pressure of the cleaning liquid supplied to the cleaning liquid deposition device from the cleaning liquid supply device in accordance with the ambient temperature measured by the temperature measurement device.

### BACKGROUND OF THE INVENTION

1. Field of the Invention

The present invention relates to a liquid ejection head cleaning apparatus and an image recording apparatus, and more particularly to technology for cleaning a liquid ejection surface of a liquid ejection head.

2. Description of the Related Art

As a general image recording apparatus, it is suitable to use an inkjet recording apparatus, which forms a desired image on a recording medium by ejecting and depositing colored inks from a plurality of nozzles provided in an inkjet head. If the inkjet head is operated for a long period of time, adhering matter such as solidified ink or paper dust from the recording medium, and the like, adhere to the nozzle surface. In particular, if adhering matter becomes attached to the vicinity of the nozzles and the nozzle apertures, this gives rise to deflection of the ejection direction of the ink ejected from the nozzles, or reduction in the ejection volume, and so on, and therefore an inkjet recording apparatus is composed in such a manner that cleaning of the nozzle surface is carried out appropriately.

Japanese Patent Application Publication No. 2009-006492 discloses a fluid spouting device which applies a cleaning liquid in a non-contact fashion to a nozzle surface of an inkjet head, by spouting the cleaning liquid from a cleaning liquid spouting unit toward the nozzle surface (see FIGS. 11 and 12, for example). In this fluid spouting device, the supply of cleaning liquid to the cleaning liquid spouting unit from a cleaning liquid tank is carried out through a pump.

The principal methods of supplying the cleaning liquid are a pumping method and a liquid head differential method. With the pumping method, however, pulsation occurs when the cleaning liquid is supplied, and it is not possible to apply the cleaning liquid in a stable and uniform fashion to the inkjet head. Accordingly, the method of supplying cleaning liquid using a liquid head differential (liquid head differential method) is considered to be the most straightforward method, since it does not induce pulsation.

FIG. 21 shows an example of the composition of an inkjet head cleaning apparatus in the related art. The inkjet head cleaning apparatus shown in FIG. 21 includes a cleaning liquid spouting unit 902 having a cleaning liquid spouting surface 902A in a position opposing a nozzle surface (ejection surface) 900A of an inkjet head 900, and a cleaning liquid tank 904 containing the cleaning liquid. The surface of the cleaning liquid in the cleaning liquid tank 904 is disposed higher than the cleaning liquid spouting surface 902A of the cleaning liquid spouting unit 902, and the cleaning liquid is supplied from the cleaning liquid tank 904 to the cleaning liquid spouting unit 902 through a supply flow channel 906 by the liquid head differential H between the liquid surface in the cleaning liquid tank 904 and the cleaning liquid spouting surface 902. The cleaning liquid 908 is spouted from the cleaning liquid spouting surface 902A of the cleaning liquid spouting unit 902, the cleaning liquid is thereby applied to the nozzle surface 900A of the inkjet head 900, and the nozzle surface 900A is wiped with a wiping member (web or blade, etc.), which is not illustrated.

However, since the viscosity of the cleaning liquid changes with the temperature, then in the inkjet head cleaning apparatus in the related art shown in FIG. 21, if a change in the temperature of the cleaning liquid occurs due to change in the ambient temperature, the amount (height h) of the cleaning liquid spouted from the cleaning liquid spouting unit 902 varies, and the cleaning liquid cannot be stably applied.

FIG. 22 is a table for describing problems that occur with change in the ambient temperature. In FIG. 22, an ambient temperature of normal temperature (25° C.) is taken as a reference temperature. As shown in FIG. 22, when the ambient temperature is lower than normal temperature, then the supply rate (flow rate) of the cleaning liquid is reduced because the viscosity of the cleaning liquid becomes higher, and there arises a problem of insufficient height of the cleaning liquid spouted from the cleaning liquid spouting unit 902. On the other hand, if the ambient temperature is higher than normal temperature, then the supply rate (flow rate) of the cleaning liquid is increased because the viscosity of the cleaning liquid becomes lower, and there arises a problem in that the height of the cleaning liquid spouted from the cleaning liquid unit 902 increases and the consumption of the cleaning liquid increases.

### SUMMARY OF THE INVENTION

The present invention has been contrived in view of these circumstances, an object thereof being to provide a liquid ejection head cleaning apparatus and an image recording apparatus, whereby cleaning liquid can be stably applied to a liquid ejection surface of a liquid ejection head irrespective of the ambient temperature.

In order to attain the aforementioned object, the present invention is directed to a liquid ejection head cleaning apparatus, comprising: a cleaning liquid deposition device which spouts cleaning liquid from a plurality of cleaning liquid nozzles and deposits the cleaning liquid onto an ejection surface of a liquid ejection head; a cleaning liquid supply device which supplies the cleaning liquid to the cleaning liquid nozzles by using a liquid head differential with respect to the cleaning liquid deposition device; a temperature measurement device which measures an ambient temperature around the cleaning liquid supply device; and a pressure control device which controls a pressure of the cleaning liquid supplied to the cleaning liquid deposition device from the cleaning liquid supply device in accordance with the ambient temperature measured by the temperature measurement device.

According to this aspect of the present invention, it is possible to suppress variation in the flow rate of the cleaning liquid supplied to the cleaning liquid nozzles caused by variation in the ambient temperature, and hence the height of the cleaning liquid spouted from the cleaning liquid nozzles can be kept uniform irrespective of the variation in the ambient temperature. Consequently, it is possible to apply the cleaning liquid stably to the liquid ejection surface of the liquid ejection head.

Preferably, the apparatus further comprises a pressure adjustment device which adjusts a pressure inside the cleaning liquid supply device, wherein the pressure control device changes the pressure inside the cleaning liquid supply device by controlling the pressure adjustment device in accordance with the ambient temperature measured by the temperature measurement device.

Preferably, the apparatus further comprises an elevator device which changes a height of the cleaning liquid supply device with respect to the cleaning liquid deposition device, wherein the pressure control device changes the height of the cleaning liquid supply device by controlling the elevator device in accordance with the ambient temperature measured by the temperature measurement device.

Preferably, the apparatus further comprises a liquid surface height adjustment device which adjusts a height of a surface of the cleaning liquid inside the cleaning liquid supply device, wherein the pressure control device changes the height of the surface of the cleaning liquid inside the cleaning liquid supply device by controlling the liquid surface height adjustment device in accordance with the ambient temperature measured by the temperature measurement device.

Preferably, the apparatus further comprises: a supply flow channel which connects the cleaning liquid supply device to the cleaning liquid deposition device; and a flow channel resistance adjustment device which adjusts a flow channel resistance of the supply flow channel, wherein the pressure control device changes the flow channel resistance of the supply flow channel by controlling the flow channel resistance adjustment device in accordance with the ambient temperature measured by the temperature measurement device.

Preferably, the flow channel resistance adjustment device includes: a plurality of parallel flow channels connected in parallel to the supply flow channel; and a flow channel selecting device which selects at least one of the parallel flow channels; and the pressure control device controls the flow channel selecting device in accordance with the ambient temperature measured by the temperature measurement device.

Preferably, at least one of the parallel flow channels has a valve device to open and close the at least one of the parallel flow channels; and the pressure control device selects at least one of the parallel flow channels by controlling the valve device in accordance with the ambient temperature measured by the temperature measurement device.

Preferably, the parallel flow channels have mutually different lengths.

Preferably, the parallel flow channels have restrictor sections, respectively, the restrictor sections having mutually different flow channel cross-sectional areas.

Preferably, the pressure control device always selects, apart from the at least one of the parallel flow channels having the valve device, another of the parallel flow channels, and additionally selects the at least one of the parallel flow channels having the valve device by controlling the valve device in accordance with the ambient temperature measured by the temperature measurement device.

Preferably, at least two of the parallel flow channels have valve devices to open and close respectively the at least two of the parallel flow channels, the valve devices having mutually different Cv values; and the pressure control device selects at least one of the parallel flow channels by controlling the valve device in accordance with the ambient temperature measured by the temperature measurement device.

Preferably, the apparatus further comprises a cleaning liquid temperature adjustment device which adjusts a temperature of the cleaning liquid in the cleaning liquid supply device.

Preferably, the cleaning liquid deposition device includes a flow rate adjustment device which adjusts a flow rate of the cleaning liquid supplied to each of the cleaning liquid nozzles in such a manner that heights of the cleaning liquid spouted from the cleaning liquid nozzles are uniform.

Preferably, the cleaning liquid deposition device includes the cleaning liquid nozzles arranged along a prescribed alignment direction and has a flow channel connecting to the cleaning liquid nozzles; and the flow channel has a restrictor having a width less than a diameter of each of the cleaning liquid nozzles.

Preferably, the restrictor includes a groove formed along the alignment direction of the cleaning liquid nozzles.

Preferably, the cleaning liquid deposition device has an inlet port through which the cleaning liquid is introduced from the cleaning liquid supply device; a first flow channel resistance from the inlet port to the cleaning liquid nozzles arranged in a first region is larger than a second flow channel resistance from the inlet port to the cleaning liquid nozzles arranged in a second region; and a first interval between the cleaning liquid nozzles arranged in the first region is smaller than a second interval between the cleaning liquid nozzles arranged in the second region.

Preferably, the apparatus further comprises a movement device which causes the liquid ejection head and the cleaning liquid deposition device to move relatively to each other, wherein the cleaning liquid deposition device includes the cleaning liquid nozzles arranged through a length not shorter than a breadth of the liquid ejection head.

In order to attain the aforementioned object, the present invention is also directed to an image recording apparatus, comprising: a liquid ejection head having an ejection surface in which a plurality of nozzles to eject liquid are arranged; and a liquid ejection head cleaning device which deposits cleaning liquid onto the ejection surface of the liquid ejection head, the liquid ejection head cleaning device including: a cleaning liquid deposition device which spouts the cleaning liquid from a plurality of cleaning liquid nozzles and deposits the cleaning liquid onto the ejection surface of the liquid ejection head; a cleaning liquid supply device which supplies the cleaning liquid to the cleaning liquid nozzles by using a liquid head differential with respect to the cleaning liquid deposition device; a temperature measurement device which measures an ambient temperature around the cleaning liquid supply device; and a pressure control device which controls a pressure of the cleaning liquid supplied to the cleaning liquid deposition device from the cleaning liquid supply device in accordance with the ambient temperature measured by the temperature measurement device.

Preferably, the liquid ejection head cleaning device further includes a pressure adjustment device which adjusts a pressure inside the cleaning liquid supply device; and the pressure control device changes the pressure inside the cleaning liquid supply device by controlling the pressure adjustment device in accordance with the ambient temperature measured by the temperature measurement device.

Preferably, the liquid ejection head cleaning device further includes an elevator device which changes a height of the cleaning liquid supply device with respect to the cleaning liquid deposition device; and the pressure control device changes the height of the cleaning liquid supply device by controlling the elevator device in accordance with the ambient temperature measured by the temperature measurement device.

Preferably, the liquid ejection head cleaning device further includes a liquid surface height adjustment device which adjusts a height of a surface of the cleaning liquid inside the cleaning liquid supply device; and the pressure control device changes the height of the surface of the cleaning liquid inside the cleaning liquid supply device by controlling the liquid surface height adjustment device in accordance with the ambient temperature measured by the temperature measurement device.

Preferably, the liquid ejection head cleaning device further includes: a supply flow channel which connects the cleaning liquid supply device to the cleaning liquid deposition device; and a flow channel resistance adjustment device which adjusts a flow channel resistance of the supply flow channel; and the pressure control device changes the flow channel resistance of the supply flow channel by controlling the flow channel resistance adjustment device in accordance with the ambient temperature measured by the temperature measurement device.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a general schematic drawing of an inkjet image recording apparatus according to an embodiment of the present invention;

FIGS. 2A to 2C are plan view perspective diagrams showing embodiments of the inkjet head in FIG. 1;

FIG. 3 is a cross-sectional diagram showing the inner composition of an ink chamber unit;

FIG. 4 is a principal block diagram showing the system configuration of the inkjet image recording apparatus in FIG. 1;

FIG. 5 is a schematic drawing showing a composition of a cleaning processing unit according to a first embodiment;

FIG. 6 is a plan diagram showing a composition of a cleaning liquid spouting surface of the cleaning liquid application unit;

FIGS. 7A and 7B are illustrative diagrams showing height variations of cleaning liquid pillars formed on the cleaning liquid spouting surface of the cleaning liquid application unit;

FIG. 8 is a cross-sectional perspective diagram showing an enlarged view of the vicinity of the cleaning liquid spouting surface of the cleaning liquid application unit;

FIG. 9 is a plan diagram showing another composition of the cleaning liquid spouting surface of the cleaning liquid application unit;

FIG. 10 is an illustrative diagram showing an embodiment of control performed by the cleaning process control unit;

FIG. 11 is a schematic drawing showing the composition of the cleaning processing unit according to a second embodiment;

FIG. 12 is a schematic drawing showing the composition of the cleaning processing unit according to a third embodiment;

FIG. 13 is a schematic drawing showing the composition of the cleaning processing unit according to a fourth embodiment;

FIG. 14 is a schematic drawing showing the composition of the cleaning processing unit according to a fifth embodiment;

FIG. 15 is a schematic drawing showing the composition of the cleaning processing unit according to a sixth embodiment;

FIG. 16 is a schematic drawing showing a first embodiment of the composition of the flow channel resistance adjustment unit;

FIG. 17 is a schematic drawing showing a second embodiment of the composition of the flow channel resistance adjustment unit;

FIG. 18 is a schematic drawing showing a third embodiment of the composition of the flow channel resistance adjustment unit;

FIG. 19 is a schematic drawing showing a fourth embodiment of the composition of the flow channel resistance adjustment unit;

FIG. 20 is a schematic drawing showing a mode where a cleaning liquid temperature adjustment device is arranged in a cleaning liquid tank;

FIG. 21 is a schematic drawing showing an example of the composition of an inkjet head cleaning apparatus in the related art; and

FIG. 22 is a table for describing problems of the inkjet head cleaning apparatus in the related art.

### DETAILED DESCRIPTION OF THE PREFERRED EMBODIMENTS

### Entire Configuration of Inkjet Recording Apparatus

First, an inkjet recording apparatus will be described as an embodiment of an image formation apparatus according to the present invention.

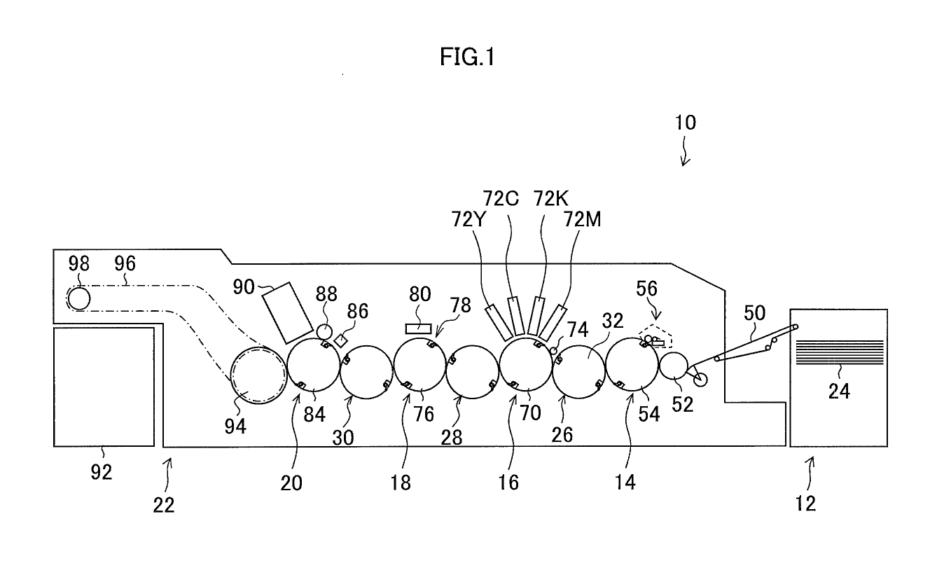

FIG. 1 is a structural diagram illustrating the entire configuration of an inkjet recording apparatus 10 according to an embodiment of the present invention. The inkjet recording apparatus 10 shown in the drawing is an recording apparatus in a two-liquid aggregating system of forming an image on a recording surface of a recording medium 24 by using ink (an aqueous ink) and a treatment liquid (aggregation treatment liquid). The inkjet recording apparatus 10 includes a paper feed unit 12, a treatment liquid application unit 14, an image formation unit 16, a drying unit 18, a fixing unit 20, and a discharge unit 22 as the main components. A recording medium 24 (paper sheets) is stacked in the paper feed unit 12, and the recording medium 24 is fed from the paper feed unit 12 to the treatment liquid application unit 14. A treatment liquid is applied to the recording surface in the treatment liquid application unit 14, and then a color ink is applied to the recording surface in the image formation unit 16. The image is fixed with the fixing unit 20 on the recording medium 24 onto which the ink has been applied, and then the recording medium is discharged with the discharge unit 22.

In the inkjet recording apparatus 10, intermediate conveyance units 26, 28 and 30 are provided between the units, and the recording medium 24 is transferred by these intermediate conveyance units 26, 28 and 30. Thus, a first intermediate conveyance unit 26 is provided between the treatment liquid application unit 14 and image formation unit 16, and the recording medium 24 is transferred from the treatment liquid application unit 14 to the image formation unit 16 by the first intermediate conveyance unit 26. Likewise, the second intermediate conveyance unit 28 is provided between the image formation unit 16 and the drying unit 18, and the recording medium 24 is transferred from the image formation unit 16 to the drying unit 18 by the second intermediate conveyance unit 28. Further, a third intermediate conveyance unit 30 is provided between the drying unit 18 and the fixing unit 20, and the recording medium 24 is transferred from the drying unit 18 to the fixing unit 20 by the third intermediate conveyance unit 30.

Each unit (paper feed unit 12, treatment liquid application unit 14, image formation unit 16, drying unit 18, fixing unit 20, and discharge unit 22) of the inkjet recording apparatus 10 will be described below in greater details.

### <Paper Feed Unit>

The paper feed unit 12 feeds the recording medium 24 to the image formation unit 16. A paper feed tray 50 is provided in the paper feed unit 12, and the recording medium 24 is fed, sheet by sheet, from the paper feed tray 50 to the treatment liquid application unit 14.

### <Treatment Liquid Application Unit>

The treatment liquid application unit 14 is a mechanism that applies a treatment liquid to the recording surface of the recording medium 24. The treatment liquid includes a coloring material aggregating agent that causes the aggregation of a coloring material (pigment) included in the ink applied in the image formation unit 16, and the separation of the coloring material and a solvent in the ink is enhanced when the treatment liquid is brought into contact with the ink.

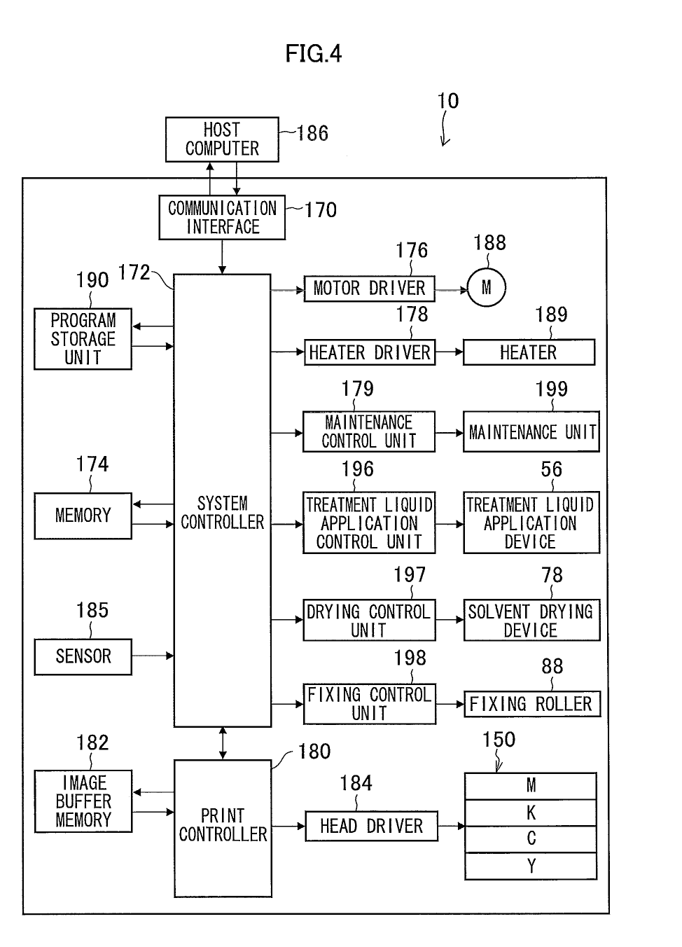

As shown in FIG. 1, the treatment liquid application unit 14 includes a paper transfer drum 52, a treatment liquid drum 54, and a treatment liquid application device 56. The paper transfer drum 52 is disposed between the paper feed tray 50 of the paper feed unit 12 and the treatment liquid drum 54. The rotation of the paper transfer drum 52 is driven and controlled by a below-described motor driver 176 (see FIG. 4). The recording medium 24 fed from the paper feed unit 12 is received by the paper transfer drum 52 and transferred to the treatment liquid drum 54. The below-described intermediate conveyance unit may be also provided instead of the paper transfer drum 52.

The treatment liquid drum 54 is a drum that holds and rotationally conveys the recording medium 24. The rotation of the treatment liquid drum 54 is driven and controlled by the below-described motor driver 176 (see FIG. 4). Further, the treatment liquid drum 54 is provided on the outer circumferential surface thereof with a hook-shaped holding device, by which the leading end of the recording medium 24 can be held. In a state in which the leading end of the recording medium 24 is held by the holding device, the treatment liquid drum 54 is rotated to rotationally convey the recording medium 24. In this case, the recording medium 24 is conveyed in a state where the recording surface thereof faces outward. The treatment liquid drum 54 may be provided with suction apertures on the outer circumferential surface thereof and connected to a suction device that performs suction from the suction apertures. As a result, the recording medium 24 can be held in a state of tight adherence to the outer circumferential surface of the treatment liquid drum 54.

The treatment liquid application device 56 is provided on the outside of the treatment liquid drum 54 opposite the outer circumferential surface thereof. The treatment liquid application device 56 applies the treatment liquid onto the recording surface of the recording medium 24. The treatment liquid application device 56 includes: a treatment liquid container, in which the treatment liquid to be applied is held; an anilox roller, a part of which is immersed in the treatment liquid held in the treatment liquid container; and a rubber roller, which is pressed against the anilox roller and the recording medium 24 that is held by the treatment liquid drum 54, so as to transfer the treatment liquid metered by the anilox roller 64 to the recording medium 24.

With the treatment liquid application device 56 of the above-described configuration, the treatment liquid is applied onto the recording medium 24, while being metered. In this case, it is preferred that the film thickness of the treatment liquid be sufficiently smaller than the diameter of ink droplets that are ejected from heads (inkjet heads) 72M, 72K, 72C and 72Y of the image formation unit 16.

In the present embodiment, the application system using the roller is used to deposit the treatment liquid onto the recording surface of the recording medium 24; however, the present invention is not limited to this, and it is possible to employ a spraying method, an inkjet method, or other methods of various types.

### <Image Formation Unit>

The image formation unit 16 is a mechanism which prints an image corresponding to an input image by ejecting and depositing droplets of ink by an inkjet method, and the image formation unit 16 includes an image formation drum 70, a paper pressing roller 74 and the heads 72M, 72K, 72C and 72Y. The heads 72M, 72K, 72C and 72Y correspond to inks of four colors: magenta (M), black (K), cyan (C) and yellow (Y), and are disposed in the order of description from the upstream side in the rotation direction of the image formation drum 70.

The image formation drum 70 is a drum that holds the recording medium 24 on the outer circumferential surface thereof and rotationally conveys the recording medium 24. The rotation of the image formation drum 70 is driven and controlled by the below-described motor driver 176 (see FIG. 4).

Further, the image formation drum 70 is provided on the outer circumferential surface thereof with a hook-shaped holding device, by which the leading end of the recording medium 24 can be held. In a state in which the leading end of the recording medium 24 is held by the holding device, the image formation drum 70 is rotated to rotationally convey the recording medium 24. In this case, the recording medium 24 is conveyed in a state where the recording surface thereof faces outward, and inks are deposited on the recording surface by the heads 72M, 72K, 72C and 72Y.

The paper pressing roller 74 is a guide member for causing the recording medium 24 to tightly adhere to the outer circumferential surface of the image formation drum 70, and is arranged so as to face the outer circumferential surface of the image formation drum 70. More specifically, the paper pressing roller 74 is disposed to the downstream side of the position where transfer of the recording medium 24 is received, and to the upstream side from the heads 72M, 72K, 72C and 72Y, in terms of the direction of conveyance of the recording medium 24 (the direction of rotation of the image formation drum 70).

When the recording medium 24 that has been transferred onto the image formation drum 70 from the intermediate conveyance unit 26 is rotationally conveyed in a state where the leading end portion of the recording medium 24 is held by the holding device, the recording medium 24 is pressed by the paper pressing roller 74 to tightly adhere to the outer circumferential surface of the image formation drum 70. When the recording medium 24 has been made to tightly adhere to the outer circumferential surface of the image formation drum 70 in this way, the recording medium 24 is conveyed to a print region directly below the heads 72M, 72K, 72C and 72Y in a state where the recording medium 24 does not float up at all from the outer circumferential surface of the image formation drum 70.

The heads 72M, 72K, 72C and 72Y are inkjet heads (inkjet heads) of the inkjet system of the full line type that have a length corresponding to the maximum width of the image formation region in the recording medium 24. A nozzle row is formed on the ink ejection surface of the inkjet head. The nozzle row has a plurality of nozzles arranged therein for discharging ink over the entire width of the image recording region. Each of the heads 72M, 72K, 72C and 72Y is fixedly disposed so as to extend in the direction perpendicular to the conveyance direction (rotation direction of the image formation drum 70) of the recording medium 24.

Furthermore, each of the heads 72M, 72K, 72C and 72Y is disposed at an inclination with respect to the horizontal, in such a manner that each of the nozzle surfaces of the heads 72M, 72K, 72C and 72Y is substantially parallel to the recording surface of the recording medium 24 held on the outer circumferential surface of the image formation drum 70.

Droplets of corresponding colored inks are ejected from the inkjet heads 72M, 72K, 72C and 72Y having the above-described configuration toward the recording surface of the recording medium 24 held on the outer circumferential surface of the image formation drum 70. As a result, the ink comes into contact with the treatment liquid that has been heretofore applied on the recording surface by the treatment liquid application unit 14, the coloring material (pigment) dispersed in the ink is aggregated, and a coloring material aggregate is formed. Therefore, the coloring material flow on the recording medium 24 is prevented and an image is formed on the recording surface of the recording medium 24. In this case, because the image formation drum 70 of the image formation unit 16 is structurally separated from the treatment liquid drum 54 of the treatment liquid application unit 14, the treatment liquid does not adhere to the heads 72M, 72K, 72C and 72Y, and the number of factors preventing the ejection of ink can be reduced.

In the present embodiment, the CMYK standard color (four colors) configuration is described, but combinations of ink colors and numbers of colors are not limited to that of the present embodiment, and if necessary, light inks, dark inks, and special color inks may be added. For example, a configuration is possible in which inkjet heads are added that eject light inks such as light cyan and light magenta. The arrangement order of color heads is also not limited.

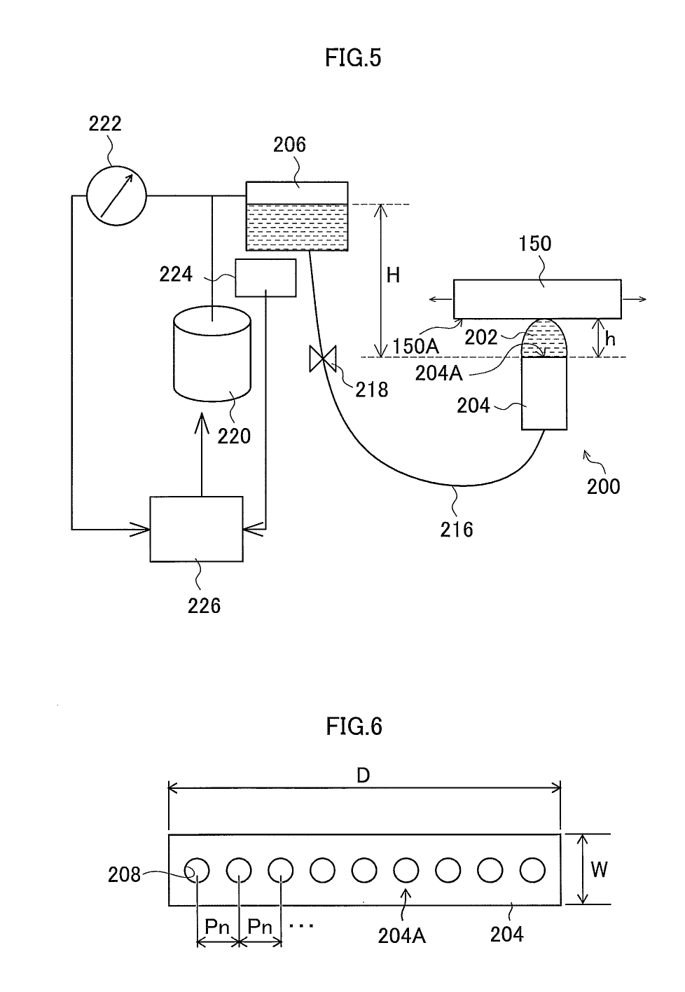

Furthermore, although not shown in FIG. 1, a cleaning processing unit 200 (see FIG. 5) is arranged at a position adjacent to the image formation drum 70 of the image formation unit 16 along the axial direction thereof, and the heads 72M, 72K, 72C and 72Y are composed so as to be movable between an image formation position opposing the image formation drum 70 and a maintenance position where the cleaning processing unit 200, and the like, are disposed, by means of a head movement mechanism (not shown).

### <Drying Unit>

The drying unit 18 dries water included in the solvent separated by the coloring material aggregation action. As shown in FIG. 1, the drying unit includes a drying drum 76 and a solvent dryer 78.

The drying drum 76 is a drum that holds the recording medium 24 on the outer circumferential surface thereof and rotationally conveys the recording medium 24. The rotation of the drying drum 76 is driven and controlled by the below-described motor driver 176 (see FIG. 4). Further, the drying drum 76 is provided on the outer circumferential surface thereof with a hook-shaped holding device, by which the leading end of the recording medium 24 can be held. In a state in which the leading end of the recording medium 24 is held by the holding device, the drying drum 76 is rotated to rotationally convey the recording medium. In this case, the recording medium 24 is conveyed in a state where the recording surface thereof faces outward. The drying treatment is carried out by the solvent dryer 78 with respect to the recording surface of the recording medium 24. The drying drum 76 may be provided with suction apertures on the outer circumferential surface thereof and connected to a suction device that performs suction from the suction apertures. As a result, the recording medium 24 can be held in a state of tight adherence to the outer circumferential surface of the drying drum 76.

The solvent dryer 78 is disposed in a position facing the outer circumferential surface of the drying drum 76, and includes a halogen heater 80. The halogen heater 80 is controlled to blow warm air at a prescribed temperature at a constant blowing rate toward the recording medium 24.

With the solvent dryer 78 of the above-described configuration, water included in the ink solvent on the recording surface of the recording medium 24 held by the drying drum 76 is evaporated, and drying treatment is performed. In this case, because the drying drum 76 of the drying unit 18 is structurally separated from the image formation drum 70 of the image formation unit 16, the number of ink non-ejection events caused by drying of the head meniscus portion by thermal drying can be reduced in the heads 72M, 72K, 72C and 72Y. Further, there is a degree of freedom in setting the temperature of the drying unit 18, and the optimum drying temperature can be set.

By holding the recording medium 24 in such a manner that the recording surface thereof is facing outward on the outer circumferential surface of the drying drum 76 having this composition (in other words, in a state where the recording surface of the recording medium 24 is curved in a convex shape), and drying while conveying the recording medium in rotation, it is possible to prevent the occurrence of wrinkles or floating up of the recording medium 24, and therefore drying non-uniformities caused by these phenomena can be prevented reliably.

### <Fixing Unit>

The fixing unit 20 includes a fixing drum 84, a halogen heater 86, a fixing roller 88, and an inline sensor 90. The halogen heater 86, the fixing roller 88, and the inline sensor 90 are arranged in positions opposite the outer circumferential surface of the fixing drum 84 in this order from the upstream side in the rotation direction (counterclockwise direction in FIG. 1) of the fixing drum 84.

The fixing drum 84 a drum that holds the recording medium 24 on the outer circumferential surface thereof and rotationally conveys the recording medium 24. The rotation of the fixing drum 84 is driven and controlled by the below-described motor driver 176 (see FIG. 4). The fixing drum 84 has a hook-shaped holding device, and the leading end of the recording medium 24 can be held by this holding device. The recording medium 24 is rotationally conveyed by rotating the fixing drum 84 in a state in which the leading end of the recording medium 24 is held by the holding device. In this case, the recording medium 24 is conveyed in a state where the recording surface thereof faces outward, and the preheating by the halogen heater 86, the fixing treatment by the fixing roller 88 and the inspection by the inline sensor 90 are performed with respect to the recording surface. The fixing drum 84 may be provided with suction apertures on the outer circumferential surface thereof and connected to a suction device that performs suction from the suction apertures. As a result, the recording medium 24 can be held in a state of tight adherence to the outer circumferential surface of the fixing drum 84.

The halogen heater 86 is controlled to a prescribed temperature, by which the preheating is performed with respect to the recording medium 24.

The fixing roller 88 is a roller member which applies heat and pressure to the dried ink to melt and fix the self-dispersible polymer particles in the ink so as to transform the ink into the film. More specifically, the fixing roller 88 is arranged so as to be pressed against the fixing drum 84, and a nip roller is configured between the fixing roller 88 and the fixing drum 84. As a result, the recording medium 24 is squeezed between the fixing roller 88 and the fixing drum 84, nipped under a prescribed nip pressure, and subjected to fixing treatment.

Further, the fixing roller 88 is configured by a heating roller in which a halogen lamp is incorporated in a metal pipe, for example made from aluminum, having good thermal conductivity and the rollers are controlled to a prescribed temperature. Where the recording medium 24 is heated with the heating roller, thermal energy not lower than a Tg temperature (glass transition temperature) of a latex included in the ink is applied and latex particles are melted. As a result, fixing is performed by penetration into the projections-recessions of the recording medium 24, the projections-recessions of the image surface are leveled out, and gloss is obtained.

The fixing unit 20 is provided with the single fixing roller 88 in the above-described embodiment; however, it is possible that a plurality of fixing rollers 88 depending on the thickness of image layer and Tg characteristic of latex particles. Furthermore, the surface of the fixing drum 84 may be controlled to a prescribed temperature.

On the other hand, the inline sensor 90 is a measuring device which measures the check pattern, moisture amount, surface temperature, gloss, and the like of the image fixed to the recording medium 24. A CCD sensor or the like can be used for the inline sensor 90.

With the fixing unit 20 of the above-described configuration, the latex particles located within a thin image layer formed in the drying unit 18 are melted by application of heat and pressure by the fixing roller 88. Thus, the latex particles can be reliably fixed to the recording medium 24. In addition, with the fixing unit 20, the fixing drum 84 is structurally separated from other drums. Therefore, the temperature of the fixing unit 20 can be freely set separately from the image formation unit 16 and the drying unit 18.

### <Discharge Unit>

As shown in FIG. 1, the discharge unit 22 is provided after the fixing unit 20. The discharge unit 22 includes a discharge tray 92, and a transfer body 94, a conveying belt 96, and a tension roller 98 are provided between the discharge tray 92 and the fixing drum 84 of the fixing unit 20 so as to face the discharge tray 92 and the fixing drum 84. The recording medium 24 is fed by the transfer body 94 onto the conveying belt 96 and discharged onto the discharge tray 92.

### <Intermediate Conveyance Unit>

The structure of the first intermediate conveyance unit 26 will be described below. The second intermediate conveyance unit 28 and the third intermediate conveyance unit 30 are configured identically to the first intermediate conveyance unit 26 and the explanation thereof will be omitted.

The first intermediate conveyance unit 26 is provided with an intermediate conveyance body 32, which is a drum for receiving the recording medium 24 from a drum of a previous stage, rotationally conveying the recording medium 24, and transferring it to a drum of the subsequent stage, and is mounted to be capable of rotating freely. The intermediate conveyance body 32 is rotated by a motor 188 (not shown in FIG. 1 and shown in FIG. 4), and the rotation thereof is driven and controlled by the below-described motor driver 176 (see FIG. 4). Further, the intermediate conveyance body 32 is provided on the outer circumferential surface thereof with a hook-shaped holding device, by which the leading end of the recording medium 24 can be held. In a state in which the leading end of the recording medium 24 is held by the holding device, the intermediate conveyance body 32 is rotated to rotationally convey the recording medium 24. In this case, the recording medium 24 is conveyed in a state where the recording surface thereof faces inward, whereas the non-recording surface thereof faces outward.

The recording medium 24 conveyed by the first intermediate conveyance unit 26 is transferred to a drum of the subsequent stage (that is, the image formation drum 70). In this case, the transfer of the recording medium 24 is performed by synchronizing the holding device of the intermediate conveyance unit 26 and the holding device (the gripper 102) of the image formation unit 16. The transferred recording medium 24 is held by the image formation drum 70 and rotationally conveyed.

### <Structure of Inkjet Heads>

Next, the structure of the heads (inkjet heads) is described. The heads 72M, 72K, 72C and 72Y for the respective colored inks have the same structure, and each of the heads is hereinafter denoted with a reference numeral 150.

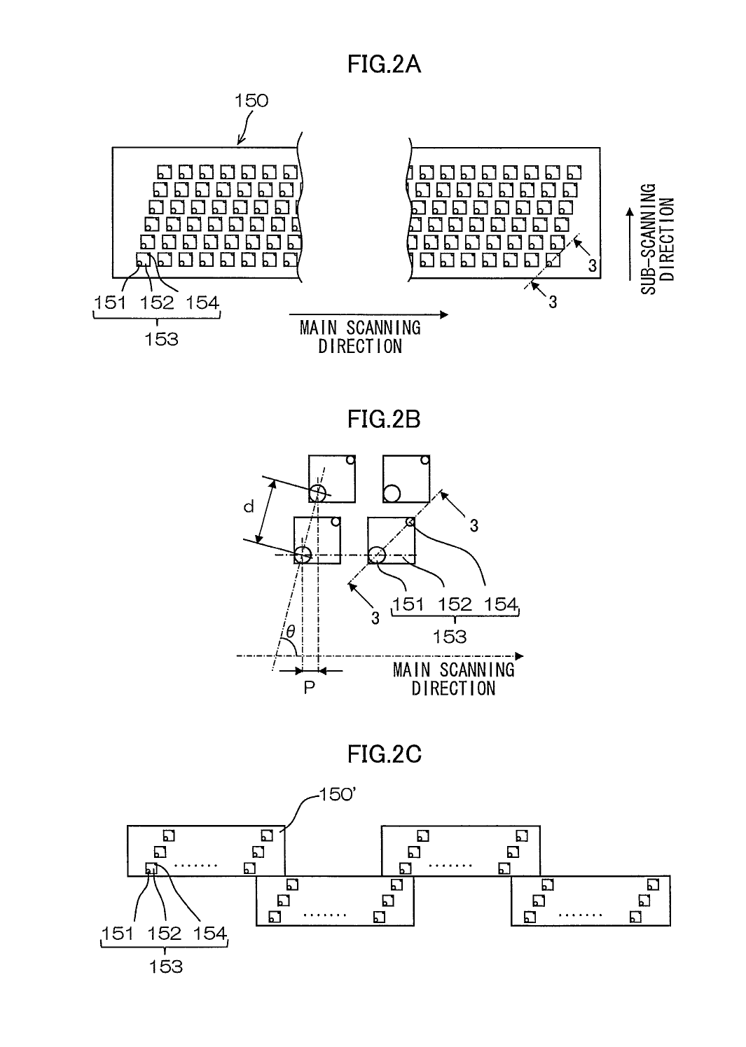

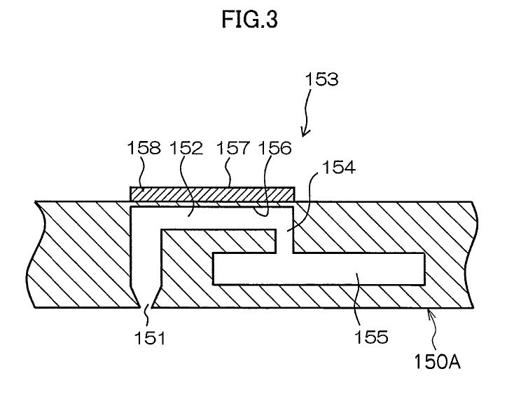

FIG. 2A is a perspective plan view showing an embodiment of the configuration of the head 150, FIG. 2B is an enlarged view of a portion thereof, and FIG. 2C is a perspective plan view showing another embodiment of the configuration of the head 150. FIG. 3 is a cross-sectional view taken along the line 3-3 in FIGS. 2A and 2B, showing the inner structure of an ink chamber unit in the head 150.

The nozzle pitch in the head 150 should be minimized in order to maximize the density of the dots printed on the surface of the recording medium 24. As shown in FIGS. 2A and 2B, the head 150 according to the present embodiment has a structure in which a plurality of ink chamber units (i.e., droplet ejection units serving as recording units) 153, each having a nozzle 151 forming an ink ejection aperture, a pressure chamber 152 corresponding to the nozzle 151, and the like, are disposed two-dimensionally in the form of a staggered matrix, and hence the effective nozzle interval (the projected nozzle pitch) as projected in the lengthwise direction of the head 150 (the main scanning direction: the direction perpendicular to the conveyance direction of the recording medium 24) is reduced and high nozzle density is achieved.

The mode of forming one or more nozzle rows through a length corresponding to the entire width of the recording medium 24 in the main scanning direction substantially perpendicular to the conveyance direction of the recording medium 24 (the sub-scanning direction) is not limited to the embodiment described above. For example, instead of the configuration in FIG. 2A, as shown in FIG. 2C, a line head having nozzle rows of a length corresponding to the entire width of the recording medium 24 can be formed by arranging and combining, in a staggered matrix, short head blocks 150′ having a plurality of nozzles 151 arrayed in a two-dimensional fashion. Furthermore, although not shown in the drawings, it is also possible to compose a line head by arranging short heads in one row.

The planar shape of the pressure chamber 152 provided for each nozzle 151 is substantially a square, and the nozzle 151 and an ink supply port 154 are disposed in both corners on a diagonal line of the square. The shape of the pressure chamber 152 is not limited to that of the present embodiment, and a variety of planar shapes, for example, a polygon such as a rectangle (rhomb, rectangle, etc.), a pentagon and a heptagon, a circle, and an ellipse can be employed.

Each pressure chamber 152 is connected to a common channel 155 through the supply port 154. The common channel 155 is connected to an ink tank (not shown), which is a base tank for supplying ink, and the ink supplied from the ink tank is delivered through the common flow channel 155 to the pressure chambers 152.

A piezoelectric element 158 provided with an individual electrode 157 is bonded to a diaphragm 156, which forms a face (the upper face in FIG. 3) of the pressure chamber 152 and also serves as a common electrode. When a drive voltage is applied to the individual electrode 157, the piezoelectric element 158 is deformed, the volume of the pressure chamber 152 is thereby changed, and the ink is ejected from the nozzle 151 by the variation in pressure that follows the variation in volume. When the piezoelectric element 158 returns to the original state after the ink has been ejected, the pressure chamber 152 is refilled with new ink from the common channel 155 through the supply port 154.

The present embodiment applies the piezoelectric elements 158 as ejection power generation devices to eject the ink from the nozzles 151 arranged in the head 150; however, instead, a thermal system that has heaters within the pressure chambers 152 to eject the ink using the pressure resulting from film boiling by the heat of the heaters can be applied.

As shown in FIG. 2B, the high-density nozzle head according to the present embodiment is achieved by arranging the plurality of ink chamber units 153 having the above-described structure in a lattice fashion based on a fixed arrangement pattern, in a row direction which coincides with the main scanning direction, and a column direction which is inclined at a fixed angle of θ with respect to the main scanning direction, rather than being perpendicular to the main scanning direction.

More specifically, by adopting a structure in which the ink chamber units 153 are arranged at a uniform pitch d in line with a direction forming the angle of θ with respect to the main scanning direction, the pitch P of the nozzles projected so as to align in the main scanning direction is d×cos θ, and hence the nozzles 151 can be regarded to be equivalent to those arranged linearly at a fixed pitch P along the main scanning direction. Such configuration results in a nozzle structure in which the nozzle row projected in the main scanning direction has a high nozzle density of up to 2,400 nozzles per inch.

When implementing the present invention, the arrangement structure of the nozzles is not limited to the embodiments shown in the drawings, and it is also possible to apply various other types of nozzle arrangements, such as an arrangement structure having one nozzle row in the sub-scanning direction.

Furthermore, the scope of application of the present invention is not limited to a printing system based on the line type of head, and it is also possible to adopt a serial system where a short head that is shorter than the breadthways dimension of the recording medium 24 is moved in the breadthways direction (main scanning direction) of the recording medium 24, thereby performing printing in the breadthways direction, and when one printing action in the breadthways direction has been completed, the recording medium 24 is moved through a prescribed amount in the sub-scanning direction perpendicular to the breadthways direction, printing in the breadthways direction of the recording medium 24 is carried out in the next printing region, and by repeating this sequence, printing is performed over the whole surface of the printing region of the recording medium 24.

### Description of Control System

FIG. 4 is a block diagram of the main portion of a system configuration of the inkjet recording apparatus 10. The inkjet recording apparatus 10 includes a communication interface 170, a system controller 172, a memory 174, the motor driver 176, a heater driver 178, a maintenance control unit 179, a printing control unit 180, an image buffer memory 182, a head driver 184, a sensor 185, a program storage unit 190, a treatment liquid application control unit 196, a drying control unit 197, and a fixing control unit 198.

The communication interface 170 is an interface unit that receives image data sent from a host computer 186. A serial interface such as USB (Universal Serial Bus), IEEE 1394, Ethernet, and a wireless network, or a parallel interface such as Centronix can be applied as the communication interface 170. A buffer memory (not shown) may be installed in the part of the interface to increase the communication speed. The image data sent from the host computer 186 are introduced into the inkjet recording apparatus 10 through the communication interface 170 and temporarily stored in the memory 174.

The memory 174 is a storage device that temporarily stores the images inputted through the communication interface 170 and reads/writes the data via the system controller 172. The memory 174 is not limited to a memory composed of semiconductor elements and may use a magnetic medium such as a hard disk.

The system controller 172 includes a central processing unit (CPU) and a peripheral circuitry thereof, functions as a control device that controls the entire inkjet recording apparatus 10 according to a predetermined program, and also functions as an operational unit that performs various computations. Thus, the system controller 172 controls various units such as the communication interface 170, the memory 174, the motor driver 176, the heater driver 178, the maintenance control unit 179, the treatment liquid application control unit 196, the drying control unit 197 and the fixing control unit 198, performs communication control with the host computer 180, performs read/write control of the memory 174, and also generates control signals for controlling the various units.

Programs that are executed by the CPU of the system controller 172 and various data necessary for performing the control are stored in the memory 174. The memory 174 may be a read-only storage device or may be a writable storage device such as EEPROM. The memory 174 can be also used as a region for temporary storing image data, a program expansion region, and a computational operation region of the CPU.

Various control programs are stored in the program storage unit 190, and a control program is read out and executed in accordance with commands from the system controller 172. The program storage unit 190 may use a semiconductor memory, such as a ROM, EEPROM, or a magnetic disk, or the like. The program storage unit 190 may be provided with an external interface, and a memory card or PC card may also be used. Naturally, a plurality of these storage media may also be provided. The program storage unit 190 may also be combined with a storage device for storing operational parameters, and the like (not shown).

The sensor 185 represents the sensors disposed in the respective sections of the inkjet recording apparatus 10. For example, the sensor 185 includes the inline sensor 90 shown in FIG. 1, temperature sensors, position determination sensors, and pressure sensors. The output signals of the sensor 185 are sent to the system controller 172, and the system controller 172 controls the respective sections of the inkjet recording apparatus 10 by sending the command signals to the respective sections in accordance with the output signals of the sensor 185.

The motor driver 176 drives a motor 188 in accordance with commands from the system controller 172. In FIG. 4, the plurality of motors disposed in the respective sections of the inkjet recording apparatus 10 are represented by the reference numeral 188. For example, the motor 188 shown in FIG. 4 includes the motors that drive the paper transfer drum 52, the treatment liquid drum 54, the image formation drum 70, the drying drum 76, the fixing drum 84 and the transfer body 94 shown in FIG. 1, and the motors that drive the intermediate conveyance bodies 32 in the first, second and third intermediate conveyance units 26, 28 and 30.

The heater driver 178 is a driver that drives the heater 189 in accordance with commands from the system controller 172. In FIG. 4, the plurality of heaters disposed in the inkjet recording apparatus 10 are represented by the reference numeral 189. For example, the heater 189 shown in FIG. 4 includes the halogen heaters 80 in the solvent dryer 78 arranged in the drying unit 18 shown in FIG. 1, and the heaters that heat the surfaces of the drying drum 76 and the fixing drum 84 shown in FIG. 1.

The maintenance control unit 179 controls the operations of the respective sections of a maintenance unit 199, in accordance with commands from the system controller 172. The cleaning processing unit 200 (see FIG. 5) described below is included in the maintenance unit 199 shown in FIG. 4. Furthermore, a cleaning processing control unit 226 (see FIG. 5), which controls the operations of the respective sections of the cleaning process unit 200, is a control block corresponding to the system controller 172 and the maintenance control unit 179.

The treatment liquid application control unit 196, the drying control unit 197 and the fixing control unit 198 control the operations of the treatment liquid application device 56, the solvent dryer 78 and the fixing roller 88, respectively, in accordance with commands from the system controller 172.

The printing control unit 180 has a signal processing function for performing a variety of processing and correction operations for generating signals for print control from the image data within the memory 174 according to control of the system controller 172, and supplies the generated printing data (dot data) to the head driver 184. The required signal processing is implemented in the printing control unit 180, and the ejection amount and ejection timing of droplets in the heads 150 are controlled through the head driver 184 based on the image data. As a result, the desired dot size and dot arrangement are realized.

The printing control unit 180 is provided with the image buffer memory 182, and data such as image data or parameters are temporarily stored in the image buffer memory 182 during image data processing in the printing control unit 180. A mode is also possible in which the printing control unit 180 and the system controller 172 are integrated and configured by one processor.

The head driver 184 generates drive signals for driving the piezoelectric elements 158 of the heads 150, on the basis of the dot data supplied from the print controller 180, and drives the piezoelectric elements 158 by applying the generated drive signals to the piezoelectric elements 158. A feedback control system for maintaining constant drive conditions in the inkjet heads 150 may be included in the head driver 184 shown in FIG. 4.

### Description of Cleaning Processing Unit

The composition of the cleaning processing unit 200 according to embodiments of the present invention is described below.

### First Embodiment

FIG. 5 is a schematic drawing showing the composition of the cleaning processing unit 200 according to the first embodiment of the present invention. In FIG. 5, the lateral direction in the drawing corresponds to the lengthwise direction of the head 150 (the main scanning direction), and the direction perpendicular to the sheet of the drawing corresponds to the breadthways direction of the head 150 (the width direction, the sub-scanning direction, the paper conveyance direction).

The cleaning processing unit 200 shown in FIG. 5 includes: a cleaning liquid application unit 204, which forms a pillar of the cleaning liquid (a cleaning liquid coating layer) 202; and a cleaning liquid tank 206, which contains the cleaning liquid to be supplied to the cleaning liquid application unit 204.

The cleaning liquid tank 206 is disposed at a position higher than the cleaning liquid application unit 204 so that the cleaning liquid is supplied from the cleaning liquid tank 206 to the cleaning liquid application unit 204 by the liquid head differential H between the liquid surface in the cleaning liquid tank 206 and a cleaning liquid spouting surface 204A of the cleaning liquid application unit 204.

The cleaning liquid application unit 204 has the cleaning liquid spouting surface 204A, which is disposed separately and opposingly to the nozzle surface 150A of the head 150. The cleaning liquid application unit 204 forms the cleaning liquid pillar 202 from the cleaning liquid spouting surface 204A, brings the top of the cleaning liquid pillar 202 into contact with the nozzle surface 150A, and thereby applies the cleaning liquid to the nozzle surface 150A.

The liquid employed as the cleaning liquid has properties capable of dissolving solidified ink adhering to the nozzle surface 150A, and is a special liquid having enhanced cleaning effects. For example, it is desirable to employ a cleaning liquid containing a solvent, such as DEGmBE (diethylene glycol monobutyl ether).

In the case of the inkjet recording apparatus having the plurality of heads 72M, 72K, 72C and 72Y as shown in FIG. 1, it is possible to adopt a composition in which the cleaning processing unit 200 is provided with a plurality of cleaning liquid application units 204 in equal number to the heads 72M, 72K, 72C and 72Y (namely, respectively for the heads 72M, 72K, 72C and 72Y), or a composition in which the number of the cleaning liquid application units 204 is fewer than the heads 72M, 72K, 72C and 72Y. In the former case, it is possible to apply the cleaning liquid to the heads 72M, 72K, 72C and 72Y by the corresponding cleaning liquid application units 204 in parallel, and hence the cleaning liquid application time can be shortened. On the other hand, in the latter case, the application of the cleaning liquid to the heads 72M, 72K, 72C and 72Y is progressively carried out while successively moving one or the plurality of cleaning liquid application units 204 fewer than the heads, then in comparison with the former case, although the cleaning liquid application time should be longer, it is possible to arrange the cleaning liquid application unit or units 204 in a smaller space, to miniaturize the cleaning processing unit 200, and to reduce costs of the cleaning processing unit 200.

Furthermore, although not shown in the drawings, the cleaning processing unit 200 is provided with a recovery tray arranged vertically below the cleaning liquid application unit 204. The recovery tray receives the cleaning liquid that has dropped down from the head 150 and the cleaning liquid application unit 204.

FIG. 6 is a plan diagram showing the composition of the cleaning liquid spouting surface 204A of the cleaning liquid application unit 204 in an embodiment of the present invention. As shown in FIG. 6, a plurality of cleaning liquid nozzles 208 are disposed at a uniform arrangement pitch of Pn through a length corresponding to the breadth of the head 150 (the dimension of the head 150 in the sub-scanning direction), on the cleaning liquid spouting surface 204A of the cleaning liquid application unit 204. The cleaning liquid nozzles 208 have cleaning liquid spouting ports (opening sections) through which the cleaning liquid supplied from the cleaning liquid tank 206 is spouted.

The dimension D of the cleaning liquid application unit 204 in the lengthwise direction thereof corresponds to the dimension of the head 150 in the breadthways direction thereof (see FIG. 5), and the length through which the cleaning liquid nozzles 208 are arranged is equal to or greater than the dimension of the head 150 in the breadthways direction thereof.

The dimension W of the cleaning liquid application unit 204 in the breadthways direction thereof is specified in accordance with the arrangement pattern of the cleaning liquid nozzles 208. FIG. 6 shows a mode where the cleaning liquid nozzles 208 are arranged in a direction substantially parallel to the lengthwise direction of the cleaning liquid application unit 204 (the breadthways direction of the head 150); however, the direction of arrangement of the cleaning liquid nozzles 208 can be an oblique direction which forms a prescribed angle with respect to the lengthwise direction of the cleaning liquid application unit 204. Furthermore, the cleaning liquid nozzles 208 can be arranged over two or more columns.

The arrangement pitch Pn of the cleaning liquid nozzles 208 is specified in such a manner that the cleaning liquid spouted from adjacent cleaning liquid nozzles 208 makes contact and combines together. In other words, the cleaning liquid spouted and caused to spread out from each of the cleaning liquid nozzles 208 joins together with the cleaning liquid spouted from the adjacent cleaning liquid nozzle 208, and the cleaning liquid pillar 202 which is connected to the cleaning liquid inside the cleaning liquid nozzles 208 and which has the dimension corresponding to the breadthways-direction dimension of the head 150 is formed. When the top of the cleaning liquid pillar 202 makes contact with the nozzle surface 150A, the surface free energy of the nozzle surface 150A acts in such a manner that a part of the top portion of the cleaning liquid pillar 202 separates off and adheres to the nozzle surface 150A.

Examples of the dimensions of the respective sections of the cleaning liquid application unit 204 are as follows: the diameter of the cleaning liquid nozzles 208 is 1 mm; the arrangement pitch Pn of the cleaning liquid nozzles 208 is 2 mm; and the width W of the cleaning liquid application unit 204 is 4 mm For example, if sixteen (16) cleaning liquid nozzles of the 1 mm diameter are arranged at the uniform pitch of 2 mm, then the dimension D of the cleaning liquid application unit 204 in the lengthwise direction thereof is approximately 50 mm.

The interval between the nozzle surface 150A of the head 150 and the cleaning liquid spouting surface 204A of the cleaning liquid application unit 204 is specified in such a manner that at least the top of the cleaning liquid pillar 202 formed on the cleaning liquid spouting surface 204A makes contact with the nozzle surface 150A (in other words, the interval is set to be less than the maximum height of the cleaning liquid pillar 202), and the amount (height) of contact made by the top portion of the cleaning liquid pillar 202 is determined in accordance with the amount of the cleaning liquid to be applied to the nozzle surface 150A. For example, the interval is set to approximately 1 mm to 2 mm.

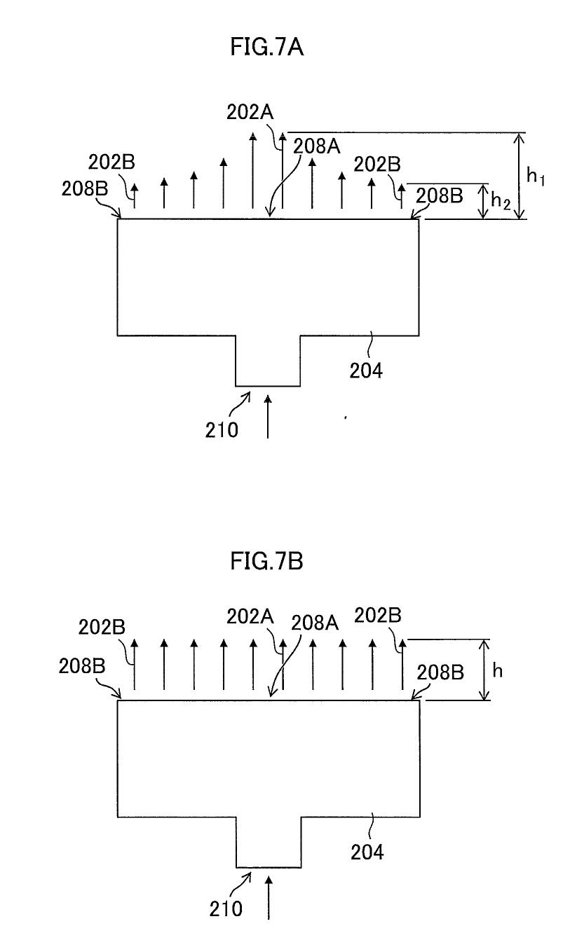

FIG. 7A is an illustrative diagram showing the height variations of cleaning liquid pillars 202A and 202B formed on the cleaning liquid spouting surface 204A of the cleaning liquid application unit 204. In FIG. 7A, the lateral direction in the drawing corresponds to the lengthwise direction of the cleaning liquid application unit 204 (the breadthways direction of the head 150, the sub-scanning direction), and the direction perpendicular to the sheet of the drawing corresponds to the breadthways direction of the cleaning liquid application unit 204 (the lengthwise direction of the head 150, the main scanning direction).

In the case of the nozzle arrangement structure in which the cleaning liquid nozzles 208 are arranged at uniform pitch as shown in FIG. 6, there are induced variations in the shapes of the cleaning liquid pillars 202A and 202B as shown in FIG. 7A due to the pressure differential caused by the differences in the flow channel lengths (i.e., the flow channel resistances) from a cleaning liquid inlet port 210 to the respective cleaning liquid nozzles 208 (see FIG. 6).

FIG. 7A shows the composition in which the inlet port 210 is arranged in substantially the central portion of the cleaning liquid application unit 204 in the lengthwise direction thereof. In this case, the cleaning liquid nozzles 208B in the end portions in terms of the lengthwise direction of the cleaning liquid application unit 204 (the direction of arrangement of the cleaning liquid nozzles 208) have a greater flow channel length from the inlet port 210 (i.e., a greater flow channel resistance) than the cleaning liquid nozzles 208A in the central portion, and the height h₂ of the cleaning liquid pillars 202B in the end portions is thereby made smaller than the height h₁ of the cleaning liquid pillar 202A in the central portion (h₁>h₂).

Hence, the cleaning liquid application unit 204 in the present embodiment is provided with restrictors arranged in the flow channels in connection with the cleaning liquid nozzles 208, so as to avoid the height variations of the cleaning liquid pillars 202A and 202B as shown in FIG. 7A due to the variations in the flow channel resistance. Thereby, as shown in FIG. 7B, the cleaning liquid pillars 202A and 202B having a uniform height h are formed throughout the lengthwise direction of the cleaning liquid application unit 204 (the direction of arrangement of the cleaning liquid nozzles 208).

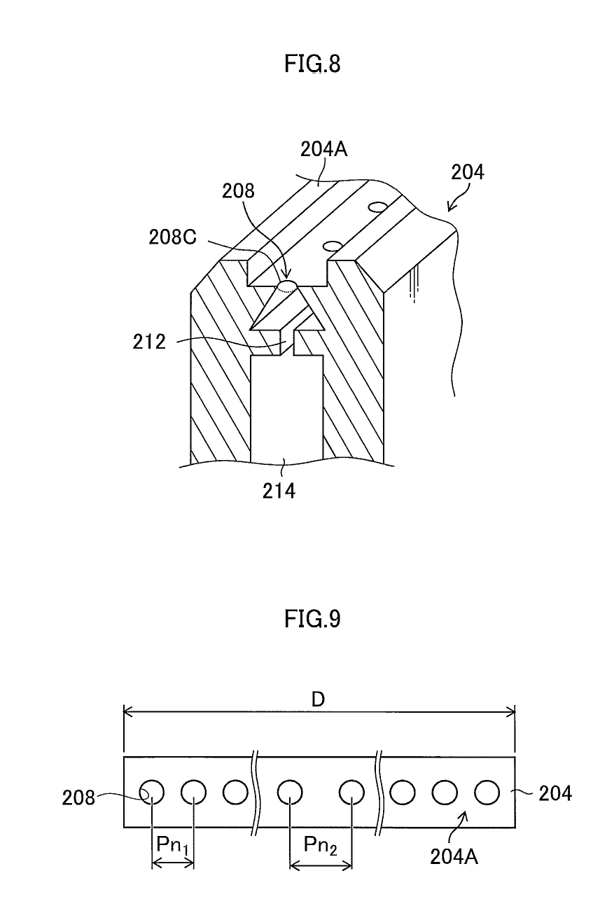

FIG. 8 is a cross-sectional perspective diagram showing an enlarged view of the vicinity of the cleaning liquid spouting surface 204A of the cleaning liquid application unit 204. As shown in FIG. 8, an aperture 208C of each cleaning liquid nozzle 208 having a substantially conical shape is formed in a recess section of the cleaning liquid spouting surface 204A of the cleaning liquid application unit 204, and the cleaning liquid nozzles 208 are provided with a common restrictor 212, which has a slit shape, directly below the cleaning liquid nozzles 208.

The restrictor 212 is constituted of as a long thin slit formed following the direction of arrangement of the cleaning liquid nozzles 208 in a position opposing the apertures 208C of the cleaning liquid nozzles 208, and having a width less than the diameter of the cleaning liquid nozzles 208. The cleaning liquid nozzles 208 and the flow channel 214 are connected through the restrictor 212.

By arranging the restrictor 212 between the cleaning liquid nozzles 208 and the flow channel 214 in this way, the pressure differential between the respective cleaning liquid nozzles 208 is cancelled out due to the pressure loss induced by the restrictor 212, whereby a uniform pressure is applied to the respective cleaning liquid nozzles 208. Thus, the height variations of the cleaning liquid pillars are suppressed, and it is possible to apply the cleaning liquid stably to the nozzle surface 150A of the head 150.

As a further method of suppressing the height variations of the cleaning liquid pillars, it is possible to adjust the arrangement pitches of the cleaning liquid nozzles 208 in such a manner that the arrangement pitch in the respective end portions in the arrangement of the cleaning liquid nozzles 208 is smaller than the arrangement pitch in the central portion in the arrangement of the cleaning liquid nozzles 208.

FIG. 9 is a plan diagram showing the composition of the cleaning liquid spouting surface 204A of the cleaning liquid application unit 204 in another embodiment, in which the arrangement pitches of the cleaning liquid nozzles 208 are differentiated as described above.

In the cleaning liquid application unit 204 shown in FIG. 9, the arrangement pitch of the cleaning liquid nozzles 208 in the respective end portions in the lengthwise direction of the cleaning liquid application unit 204 is Pn₁, and the arrangement pitch of the cleaning liquid nozzles 208 in the central portion is Pn₂, where Pn₁<Pn₂.

The ratio between the arrangement pitch Pn₂ of the cleaning liquid nozzles 208 in the central portion and the arrangement pitch Pn₁ of the cleaning liquid nozzles 208 in the end portions (Pn₂/Pn₁) is determined in such a manner that the flow channel resistance is uniform with respect to the cleaning liquid nozzles 208.

According to the mode shown in FIG. 9, it is possible to suppress the height variations of the cleaning liquid pillars throughout the lengthwise direction of the cleaning liquid application unit 204 (the direction of arrangement of the cleaning liquid nozzles 208). Thus, the amount (size) of the top portion of the cleaning liquid pillar that makes contact with the nozzle surface 150A of the head 150 is made uniform, and the cleaning liquid can be stably applied to the nozzle surface 150A.

FIG. 9 shows the mode where the arrangement pitches of the cleaning liquid nozzles 208 are differentiated in two levels for example, and the arrangement pitches of the cleaning liquid nozzles 208 can be differentiated in a greater number of levels. According to a mode in which the arrangement pitches of the cleaning liquid nozzles 208 are differentiated in a greater number of levels, it is possible to make the heights of the cleaning liquid pillars even more uniform, and further stabilization of the application of cleaning liquid to the nozzle surface 150A of the head 150 can be achieved.

Referring back to FIG. 5, the surface of the cleaning liquid in the cleaning liquid tank 206 is positioned higher than the cleaning liquid spouting surface 204A of the cleaning liquid application unit 204, and the cleaning liquid is supplied to the cleaning liquid nozzles 208 of the cleaning liquid application unit 204 from the cleaning liquid tank 206 through the supply flow channel 216 by the liquid head differential H produced between the liquid surface in the cleaning liquid tank 206 and the cleaning liquid spouting surface 204A.

The supply flow channel 216 is provided with an electromagnetic valve 218 capable of opening and closing the supply flow channel 216, and the cleaning liquid flows to the cleaning liquid application unit 204 from the cleaning liquid tank 206 when the electromagnetic valve 218 is open, and the flow of the cleaning liquid is shut off when the electromagnetic valve 218 is closed. The opening and closing of the electromagnetic valve 218 is controlled by the cleaning process control unit 226.

When applying the cleaning liquid to the nozzle surface 150A of the head 150, the electromagnetic valve 218 is opened, the cleaning liquid is supplied to the cleaning liquid application unit 204 from the cleaning liquid tank 206 through the supply flow channel 216 by the liquid head differential H, the cleaning liquid is spouted from the cleaning liquid nozzles 208 of the cleaning liquid application unit 204, and the cleaning liquid pillar 202 is produced on the cleaning liquid spouting surface 204A. The cleaning liquid can be applied to the whole of the nozzle surface 150A of the head 150 by moving the head 150 and the cleaning liquid application unit 204 relatively to each other just once in the lengthwise direction of the head 150 (the main scanning direction), while bringing the top of the cleaning liquid pillar 202 produced on the cleaning liquid spouting surface 204A in contact with the nozzle surface 150A of the head 150.

On the other hand, when the application of the cleaning liquid to the nozzle surface 150A of the head 150 is halted, then the electromagnetic valve 218 is closed, and the supply of the cleaning liquid from the cleaning liquid tank 206 to the cleaning liquid application unit 204 is halted.

In the supply method for the cleaning liquid by the liquid head differential H as in the present embodiment, if the temperature of the cleaning liquid changes due to change in the ambient temperature around the cleaning processing unit 200 (and in particular, change in the ambient temperature around the cleaning liquid tank 206), then change also occurs in the viscosity of the cleaning liquid. This would induce problems such as: change in the flow rate of the cleaning liquid supplied from the cleaning liquid tank 206 to the cleaning liquid nozzles 208 of the cleaning liquid application unit 204; change in the height of the cleaning liquid spouted from the cleaning liquid nozzles 208 (i.e., the height of the cleaning liquid pillar 202); instability of the application of the cleaning liquid; and increase in the consumption of the cleaning liquid.

In order to suppress these problems, the pressure inside the cleaning liquid tank 206 is adjusted in accordance with the ambient temperature around the cleaning processing unit 200 (and desirably, the temperature of the cleaning liquid in the cleaning liquid tank 206) in the present embodiment so that the variation in the flow rate of the cleaning liquid supplied to the cleaning liquid nozzles 208 caused by the variation in the ambient temperature is suppressed, and the height of the cleaning liquid pillar 202 produced on the cleaning liquid spouting surface 204A of the cleaning liquid application unit 204 can be kept stable. A specific composition for achieving this is described below.

The cleaning processing unit 200 shown in FIG. 5 is provided with a pressure adjustment unit 220, a pressure sensor 222 and a temperature sensor 224, in addition to the constituents described above. The cleaning process control unit 226 also controls the respective sections of the cleaning processing unit 200.

The pressure adjustment unit 220 adjusts the pressure inside the cleaning liquid tank 206, and includes a pressurization pump and a depressurization valve, which are connected to the cleaning liquid tank 206. If pressurization inside the cleaning liquid tank 206 is necessary, then the pressurization pump is driven, and if depressurization is necessary, then the depressurization value is opened. The pressure adjustment unit 220 including the pressurization pump and the depressurization valve is controlled by the cleaning process control unit 226.

The pressure sensor 222 is a pressure measurement device which measures the pressure inside the cleaning liquid tank 206. The pressure measured by the pressure sensor 222 is reported to the cleaning process control unit 226.

The temperature sensor 224 is a temperature measurement device which measures the ambient temperature around the cleaning processing unit 200 (desirably, the temperature of the cleaning liquid in the cleaning liquid tank 206). The temperature measured by the temperature sensor 224 is reported to the cleaning process control unit 226.

The cleaning process control unit 226 controls the pressure adjustment unit 220 in accordance with the temperature measured by the temperature sensor 224 (the ambient temperature around the cleaning processing unit 200, and desirably the temperature of the cleaning liquid in the cleaning liquid tank 206), in such a manner that the interior of the cleaning liquid tank 206 assumes a prescribed pressure.

More specifically, in the case of a high temperature ambience, the cleaning process control unit 226 lowers the pressure inside the cleaning liquid tank 206 so as to reduce the flow rate of the cleaning liquid supplied to the cleaning liquid nozzles 208 to suppress the height of the cleaning liquid pillar 202.

On the other hand, in the case of a low temperature ambience, the cleaning process control unit 226 raises the pressure inside the cleaning liquid tank 206 so as to raise the flow rate of the cleaning liquid supplied to the cleaning liquid nozzles 208 to push up the height of the cleaning liquid pillar 202.

Furthermore, when adjusting the pressure inside the cleaning liquid tank 206 in accordance with the temperature measured by the temperature sensor 224, the cleaning process control unit 226 performs feedback control in such a manner that the interior of the cleaning liquid tank 206 assumes a desired pressure in accordance with the pressure measure by the pressure sensor 222 (the pressure inside the cleaning liquid tank 206). Thus, it is possible to rapidly adjust the pressure inside the cleaning liquid tank 206.

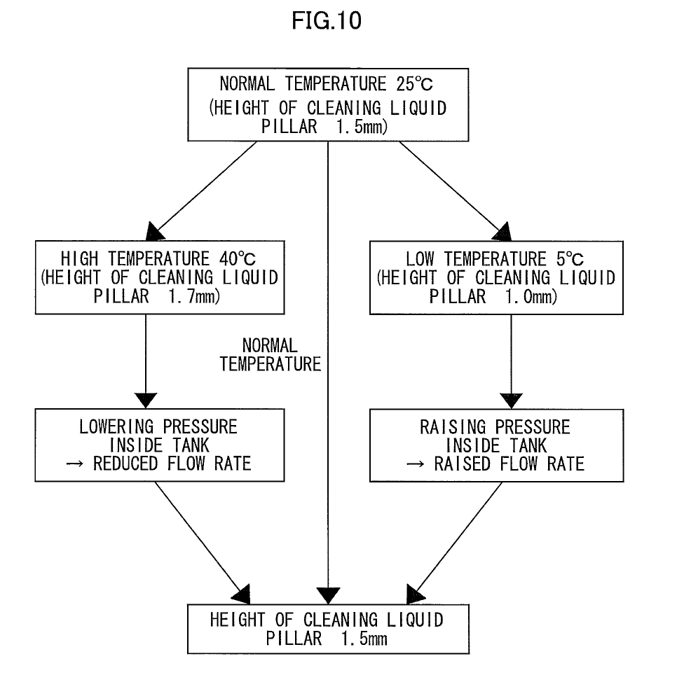

FIG. 10 is an illustrative diagram showing an embodiment of control performed by the cleaning process control unit 226. In the embodiment shown in FIG. 10, a case where the temperature measured by the temperature sensor 224 is normal temperature (25° C.) is taken as the reference temperature (reference value), and the height of the cleaning liquid pillar 202 in this case is taken to be 1.5 mm.

In this case, for example, if the temperature measured by the temperature sensor 224 is higher than normal temperature (e.g., 40° C.), the viscosity of the cleaning liquid declines, so that the height of the cleaning liquid pillar 202 would increase from 1.5 mm at normal temperature to 1.7 mm if there were no compensation. Then, the cleaning process control unit 226 opens the depressurization valve of the pressure adjustment unit 220 so as to lower the pressure inside the cleaning liquid tank 206 to reduce the flow rate of the cleaning liquid supplied to the cleaning liquid nozzles 208, and thereby keeps the height of the cleaning liquid pillar 202 to the same value of 1.5 mm as during normal temperature.

On the other hand, if the temperature measured by the temperature sensor 224 is lower than normal temperature (e.g., 5° C.), the viscosity of the cleaning liquid increases, so that the height of the cleaning liquid pillar 202 would decrease from 1.5 mm at normal temperature to 1.0 mm if there were no compensation. Then, the cleaning process control unit 226 drives the pressurization pump of the pressure adjustment unit 220 (with the depressurization valve in a closed state) so as to raise the pressure inside the cleaning liquid tank 206 to raise the flow rate of the cleaning liquid supplied to the cleaning liquid nozzles 208, and thereby keeps the height of the cleaning liquid pillar 202 to the same value of 1.5 mm as during normal temperature.

If the temperature measured by the temperature sensor 224 is normal temperature, the cleaning process control unit 226 does not make change in the pressure adjustment unit 220 and the prevailing state is maintained.

The electromagnetic valve 218, which is arranged in the supply flow channel 216 connecting the cleaning liquid tank 206 and the cleaning liquid application unit 204, is closed while the pressure inside the cleaning liquid tank 206 is being adjusted by control implemented by the cleaning process control unit 226. After the pressure adjustment has been completed, the electromagnetic valve 218 is opened, and the cleaning liquid is supplied from the cleaning liquid tank 206 through the supply flow channel 216 to the cleaning liquid nozzles 208 of the cleaning liquid application unit 204.

The relationship between the temperature measured by the temperature sensor 224 (the ambient temperature around the cleaning processing unit 200, and desirably, the temperature of the cleaning liquid in the cleaning liquid tank 206), the height of the cleaning liquid pillar 202 and the pressure measured by the pressure sensor 222 (the pressure inside the cleaning liquid tank 206) can be determined in advance by experimentation, or the like, and this relationship can be stored in a storage device (e.g., the memory 174 shown in FIG. 4, or the like), in the form of a data table. The cleaning process control unit 226 is able to control the internal pressure of the cleaning liquid tank 206 rapidly and easily by referring to the data table stored in the storage device.

Thus, according to the present embodiment, the supply of the cleaning liquid from the cleaning liquid tank 206 to the cleaning liquid nozzles 208 of the cleaning liquid application unit 204 can be performed by using the liquid head differential H produced between the cleaning liquid tank 206 and the cleaning liquid application unit 204, rather than a device which generates pulsation, such as a pump, and therefore it is possible to supply the cleaning liquid stably without pulsation.

In particular, in the present embodiment, the pressure inside the cleaning liquid tank 206 is controlled in accordance with the ambient temperature around the cleaning processing unit 200 (and desirably, the temperature of the cleaning liquid in the cleaning liquid tank 206), and the relative pressure of the cleaning liquid tank 206 with respect to the cleaning liquid application unit 204 is thereby adjusted. Thus, it is possible to suppress the variation in the flow rate of the cleaning liquid supplied to the cleaning liquid nozzles 208 caused by the variation in the ambient temperature, and the height of the cleaning liquid pillar 202 produced on the cleaning liquid spouting surface 204A of the cleaning liquid application unit 204 can be kept uniform without being affected by variations in the ambient temperature. Hence, it is possible to apply the cleaning liquid stably to the nozzle surface 150A of the head 150.

Furthermore, in the present embodiment, the cleaning liquid application unit 204 is provided with the flow rate adjustment device (e.g., the restrictor 212 in FIG. 8, the nozzle arrangement structure in FIG. 9, or the like) for adjusting the flow rate of the cleaning liquid that is supplied to the respective cleaning liquid nozzles 208, and it is thereby possible to suppress the height variations of the cleaning liquid pillar 202 through the direction of arrangement of the cleaning liquid nozzles 208. Hence, it is possible to apply the cleaning liquid uniformly without irregularities to the nozzle surface 150A of the head 150.

### Second Embodiment

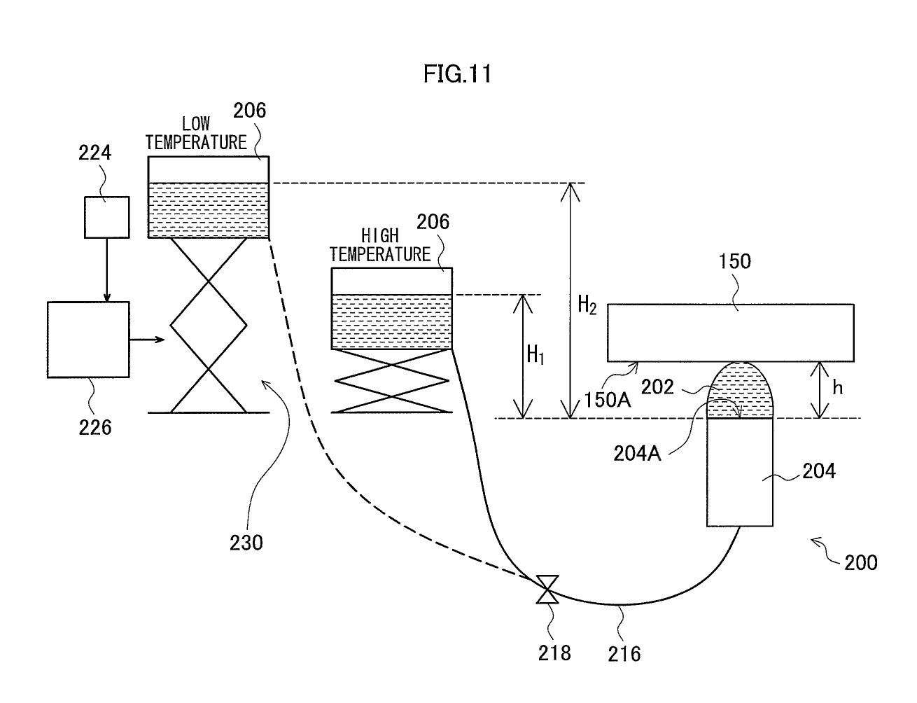

FIG. 11 is a schematic drawing showing the composition of the cleaning processing unit 200 according to the second embodiment of the present invention. In FIG. 11, members which are the same as or similar to those in FIG. 5 are denoted with the same reference numerals and description thereof is omitted here.

In the second embodiment, the liquid head differential between the cleaning liquid tank 206 and the cleaning liquid application unit 204 is altered by changing the height of arrangement of the cleaning liquid tank 206 in accordance with the ambient temperature around the cleaning processing unit 200 (desirably, the temperature of the cleaning liquid in the cleaning liquid tank 206).

The cleaning processing unit 200 shown in FIG. 11 is provided with an elevator mechanism 230, which adjusts the arrangement height of the cleaning liquid tank 206 in the vertical direction. The driving of the elevator mechanism 230 is controlled by the cleaning process control unit 226.

The cleaning process control unit 226 controls the driving of the elevator mechanism 230 in accordance with the temperature measured by the temperature sensor 224 (the ambient temperature around the cleaning processing unit 200, and desirably, the temperature of the cleaning liquid in the cleaning liquid tank 206).

More specifically, in the case of a high temperature ambience where the temperature measured by the temperature sensor 224 is higher than the reference temperature, the cleaning process control unit 226 makes the arrangement height of the cleaning liquid tank 206 lower than the reference height (to set the liquid head differential as H₁ for example) so as to reduce the flow rate of the cleaning liquid supplied to the cleaning liquid nozzles 208 to suppress the height of the cleaning liquid pillar 202.

On the other hand, in the case of a low temperature ambience where the temperature measured by the temperature sensor 224 is lower than the reference temperature, the cleaning process control unit 226 makes the arrangement height of the cleaning liquid tank 206 higher than the reference height (to set the liquid head differential as H₂ for example) so as to raise the flow rate of the cleaning liquid supplied to the cleaning liquid nozzles 208 to push up the height of the cleaning liquid pillar 202.

According to the second embodiment, the arrangement height of the cleaning liquid tank 206 is changed in accordance with the ambient temperature around the cleaning processing unit 200, the liquid head differential between the cleaning liquid tank 206 and the cleaning liquid application unit 204 is thereby adjusted, and the relative pressure of the cleaning liquid tank 206 with respect to the cleaning liquid application unit 204 is thereby adjusted. Thus, similarly to the first embodiment, it is possible to restrict variation in the flow rate of the cleaning liquid supplied to the cleaning liquid nozzles 208 caused by variation of the ambient temperature, and the height of the cleaning liquid pillar 202 produced on the cleaning liquid spouting surface 204A can be made uniform without being affected by variation in the ambient temperature. Hence, it is possible to apply the cleaning liquid stably to the nozzle surface 150A of the head 150.

### Third Embodiment

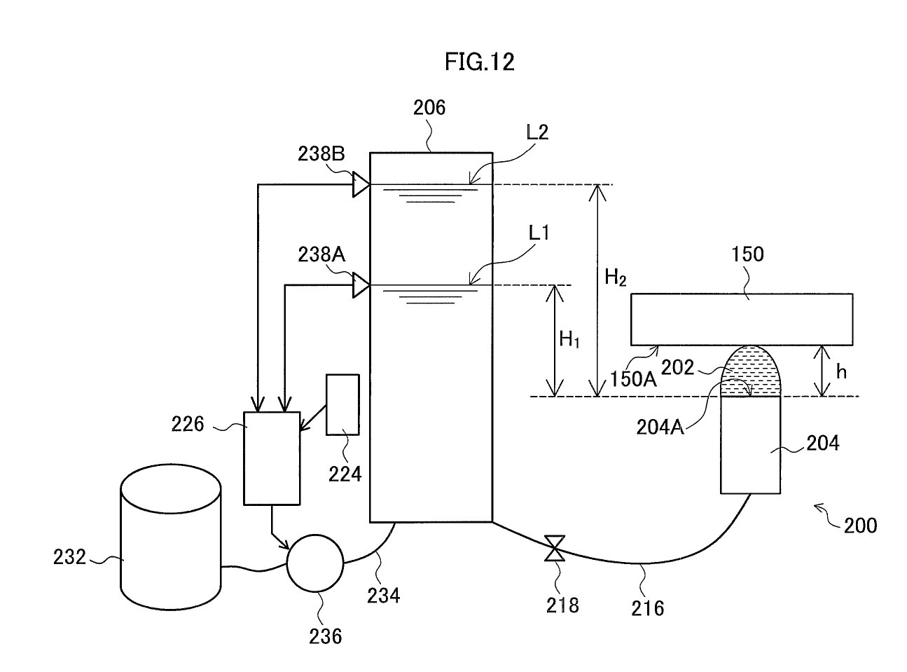

FIG. 12 is a schematic drawing showing the composition of the cleaning processing unit 200 according to the third embodiment of the present invention. In FIG. 12, members which are the same as or similar to those in FIG. 5 are denoted with the same reference numerals and description thereof is omitted here.

In the third embodiment, the liquid head differential between the cleaning liquid tank 206 and the cleaning liquid application unit 204 is altered by changing the surface height of the cleaning liquid inside the cleaning liquid tank 206 in accordance with the ambient temperature around the cleaning processing unit 200 (desirably, the temperature of the cleaning liquid in the cleaning liquid tank 206).

The cleaning processing unit 200 shown in FIG. 12 is provided with a main tank 232 and a pump 236 as devices for adjusting the surface height of the cleaning liquid inside the cleaning liquid tank 206.

It is desirable to use a tall tank as the cleaning liquid tank 206 in the third embodiment compared to the first and second embodiments, since the surface height of the cleaning liquid inside the cleaning liquid tank 206 is adjusted in accordance with the ambient temperature around the cleaning processing unit 200.

The main tank 232 serves as a cleaning liquid storage device which stores the cleaning liquid that flows out of and into the cleaning liquid tank 206. The main tank 232 is connected to the cleaning liquid tank 206 through a connecting flow channel 234, and the pump 236 is arranged in the connecting flow channel 234.

The pump 236 serves as a liquid conveyance device that is capable of conveying the cleaning liquid bidirectionally between the main tank 232 and the cleaning liquid tank 206. When the pump 236 is forwardly driven, then the cleaning liquid flows into the cleaning liquid tank 206 from the main tank 232, and the surface of the cleaning liquid inside the cleaning liquid tank 206 rises. On the other hand, when the pump 236 is reversely driven, then the cleaning liquid flows out from the cleaning liquid tank 206 to the main tank 232, and the surface of the cleaning liquid inside the cleaning liquid tank 206 falls. The driving of the pump 236 is controlled by the cleaning process control unit 226.

The cleaning liquid tank 206 is provided with a high-temperature liquid surface sensor 238A, which detects the liquid surface level L1 corresponding to a high-temperature ambience, and a low-temperature liquid surface sensor 238B, which detects the liquid surface level L2 corresponding to a low-temperature ambience. Each of the liquid surface sensors 238A and 238B sends a detection signal indicating the detection of the liquid surface to the cleaning process control unit 226, upon detecting that the cleaning liquid inside the cleaning liquid tank 206 is equal to or greater than the liquid surface height that is the detection object.

The cleaning process control unit 226 controls the driving of the pump 236 and thereby adjusts the surface height of the cleaning liquid inside the cleaning liquid tank 206 in accordance with the temperature measured by the temperature sensor 224 (the ambient temperature around the cleaning processing unit 200, and desirably, the temperature of the cleaning liquid in the cleaning liquid tank 206).

More specifically, in the case of a high-temperature ambience where the temperature measured by the temperature sensor 224 is higher than the reference temperature, the cleaning process control unit 226 controls the driving of the pump 236 to adjust the surface height of the cleaning liquid inside the cleaning liquid tank 206 to the detection position (the liquid surface level L1) of the high-temperature liquid surface sensor 238A (corresponding to the liquid head differential of H₁), so as to reduce the flow rate of the cleaning liquid supplied to the cleaning liquid nozzles 208 to suppress the height of the cleaning liquid pillar 202.

On the other hand, in the case of a low temperature ambience where the temperature measured by the temperature sensor 224 is lower than the reference temperature, the cleaning process control unit 226 controls the driving of the pump 236 to adjust the surface height of the cleaning liquid inside the cleaning liquid tank 206 to the detection position (the liquid surface level L2) of the low-temperature liquid surface sensor 238B (corresponding to the liquid head differential of H₂), so as to raise the flow rate of the cleaning liquid supplied to the cleaning liquid nozzles 208 to push up the height of the cleaning liquid pillar 202.

According to the third embodiment, the surface height of the cleaning liquid inside the cleaning liquid tank 206 is changed in accordance with the ambient temperature around the cleaning processing unit 200, the liquid head differential between the cleaning liquid tank 206 and the cleaning liquid application unit 204 is thereby adjusted, and the relative pressure of the cleaning liquid tank 206 with respect to the cleaning liquid application unit 204 is thereby adjusted. Thus, similarly to the first and second embodiments, it is possible to restrict variation in the flow rate of the cleaning liquid supplied to the cleaning liquid nozzles 208 caused by variation of the ambient temperature, and the height of the cleaning liquid pillar 202 produced on the cleaning liquid spouting surface 204A can be made uniform without being affected by variation in the ambient temperature. Hence, it is possible to apply the cleaning liquid stably to the nozzle surface 150A of the head 150.

### Fourth Embodiment

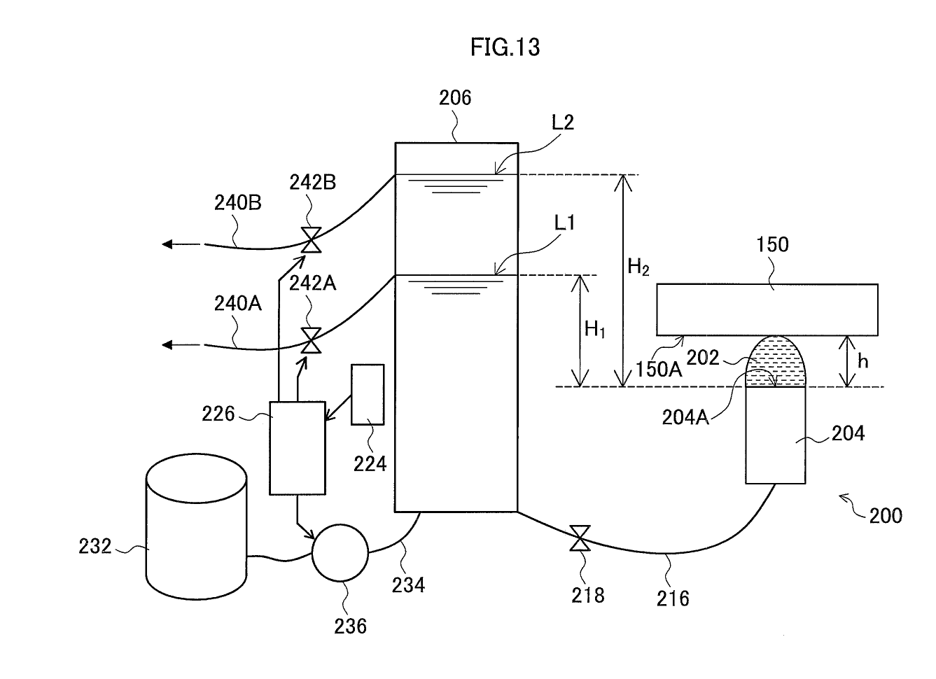

FIG. 13 is a schematic drawing showing the composition of the cleaning processing unit 200 according to the fourth embodiment of the present invention. In FIG. 13, members which are the same as or similar to those in FIGS. 5 and 12 are denoted with the same reference numerals and description thereof is omitted here.

The cleaning processing unit 200 shown in FIG. 13 is provided with a main tank 232 and a pump 236 as devices for adjusting the surface height of the cleaning liquid inside the cleaning liquid tank 206.

The pump 236 used in the present embodiment is a liquid conveyance device that is capable of conveying the cleaning liquid in one direction from the main tank 232 to the cleaning liquid tank 206. Of course, it is also possible to use the liquid conveyance device that is capable of conveying the cleaning liquid bidirectionally between the main tank 232 and the cleaning liquid tank 206 similarly to the third embodiment.

The cleaning liquid tank 206 is provided with a high-temperature drain (discharge flow channel) 240A, which is arranged at a position of the liquid surface level L1 corresponding to a high temperature ambience, and a low-temperature drain (discharge flow channel) 240B, which is arranged at a position of the liquid surface level L2 corresponding to a low temperature ambience. Electromagnetic valves 242A and 242B are arranged respectively in the drains 240A and 240B. The opening and closing of the electromagnetic valves 242A and 242B are controlled by the cleaning process control unit 226.

The cleaning process control unit 226 adjusts the surface height of the cleaning liquid inside the cleaning liquid tank 206 by a combination of controlling the driving of the pump 236 and controlling the opening and closing of the electromagnetic valves 242A and 242B, in accordance with the temperature measured by the temperature sensor 224 (the ambient temperature around the cleaning processing unit 200, and desirably, the temperature of the cleaning liquid in the cleaning liquid tank 206).

More specifically, in the case of a high temperature ambience where the temperature measured by the temperature sensor 224 is higher than the reference temperature, the cleaning process control unit 226 opens the high-temperature electromagnetic valve 242A while driving the pump 236 as required to adjust the surface height of the cleaning liquid inside the cleaning liquid tank 206 to the liquid surface level L1 (corresponding to the liquid head differential H₁), so as to reduce the flow rate of the cleaning liquid supplied to the cleaning liquid nozzles 208 to suppress the height of the cleaning liquid pillar 202.

On the other hand, in the case of a low temperature ambience where the temperature measured by the temperature sensor 224 is lower than the reference temperature, the cleaning process control unit 226 opens the low-temperature electromagnetic valve 242B while driving the pump 236 as required to adjust the surface height of the cleaning liquid inside the cleaning liquid tank 206 to the liquid surface level L2 (corresponding to the liquid head differential H₂), so as to raise the flow rate of the cleaning liquid supplied to the cleaning liquid nozzles 208 to push up the height of the cleaning liquid pillar 202.

According to the fourth embodiment, it is possible to change the height of the surface of the cleaning liquid inside the cleaning liquid tank 206 in accordance with the ambient temperature around the cleaning processing unit 200, and similar beneficial effects to those of the third embodiment described above can be obtained.

### Fifth Embodiment

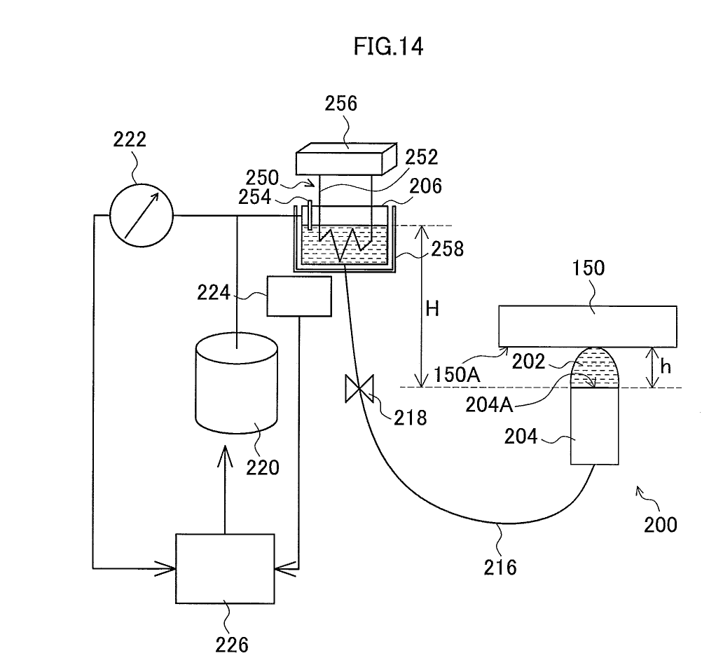

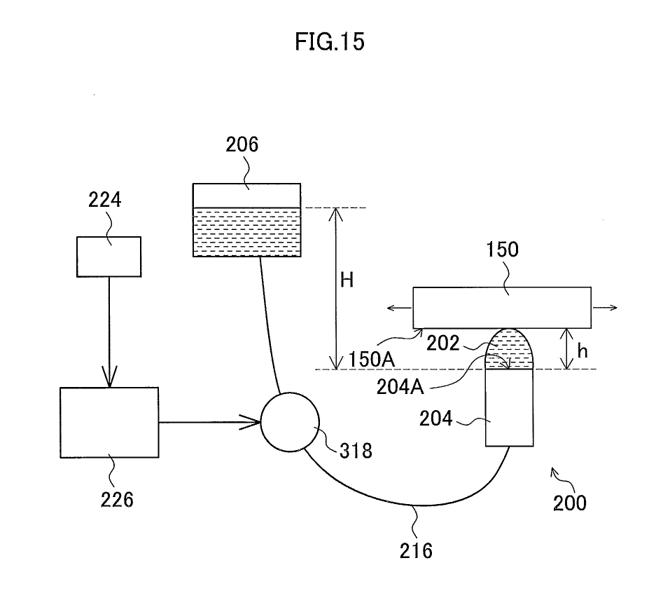

FIG. 14 is a schematic drawing showing the composition of the cleaning processing unit 200 according to the fifth embodiment of the present invention. In FIG. 14, members which are the same as or similar to those in FIG. 5 are denoted with the same reference numerals and description thereof is omitted here.

The cleaning processing unit 200 shown in FIG. 14 is provided with a cleaning liquid temperature adjustment device 250, which adjusts the temperature of the cleaning liquid in the cleaning liquid tank 206. The cleaning liquid temperature adjustment device 250 includes a heater 252, such as an in-built heater installed inside the cleaning liquid tank 206, a temperature sensor 254, which measures the temperature inside the cleaning liquid tank 206, and a temperature adjustment controller 256.

The temperature adjustment controller 256 controls the temperature of the heater 252 in accordance with the temperature inside the cleaning liquid tank 206, which is measured by the temperature sensor 254, in such a manner that the temperature of the cleaning liquid in the cleaning liquid tank 206 is kept uniform.

It is desirable that a heat insulating material 258 is arranged on the outer perimeter surfaces (the side faces and the bottom face) of the cleaning liquid tank 206. By suppressing the exchange of heat with the outside air, it is possible to reduce the change in the temperature of the cleaning liquid in the cleaning liquid tank 206.

It is also desirable that a heat insulating tube is used for the supply flow channel 216, which connects the cleaning liquid tank 206 and the cleaning liquid application unit 204. This makes it possible to reduce temperature change in the cleaning liquid flowing through the supply flow channel 216.

FIG. 14 shows one example of a composition in which the cleaning liquid temperature adjustment device 250 is employed in the cleaning processing unit 200 according to the first embodiment (see FIG. 5); however, the present invention is not limited to this and can also be applied similarly to the respective cleaning processing units 200 according to the second to fourth embodiments.

According to the fifth embodiment, control is implemented in such a manner that the temperature of the cleaning liquid in the cleaning liquid tank 206 is kept uniform by the cleaning liquid temperature adjustment device 250, and therefore it is possible reliably to suppress the variation in the flow rate of the cleaning liquid supplied to the cleaning liquid nozzles 208, and the application of the cleaning liquid to the nozzle surface 150A of the head 150 can be made even more stable.

### Sixth Embodiment

FIG. 15 is a schematic drawing showing the composition of the cleaning processing unit 200 according to the sixth embodiment of the present invention. In FIG. 15, members which are the same as or similar to those in FIG. 5 are denoted with the same reference numerals and description thereof is omitted here.

In the sixth embodiment, the flow channel resistance from the cleaning liquid tank 206 to the cleaning liquid application unit 204 is adjusted in accordance with the ambient temperature around the cleaning processing unit 200 (and desirably, the temperature of the cleaning liquid in the cleaning liquid tank 206) so as to suppress the variation in the flow rate of the cleaning liquid supplied to the cleaning liquid nozzles 208 caused by the change in the ambient temperature, and the height of the cleaning liquid pillar 202 produced on the cleaning liquid spouting surface 204A of the cleaning liquid application unit 204 can be kept stable.

The cleaning processing unit 200 shown in FIG. 15 is provided with a flow channel resistance adjustment unit 318 instead of the pressure adjustment unit 220 shown in FIG. 5.

The flow channel resistance adjustment unit 318 adjusts the flow channel resistance from the cleaning liquid tank 206 to the cleaning liquid application unit 204, and is arranged in the supply flow channel 216 connecting the cleaning liquid tank 206 and the cleaning liquid application unit 204. The flow channel resistance adjustment unit 318 is controlled by the cleaning process control unit 226.

The cleaning process control unit 226 controls the flow channel resistance adjustment unit 318 in accordance with the temperature measured by the temperature sensor 224, in such a manner that the supply flow channel 216 connecting the cleaning liquid tank 206 and the cleaning liquid application unit 204 assumes a prescribed flow channel resistance. More specifically, the flow channel resistance of the supply flow channel 216 at normal temperature (25° C.) is taken as the reference resistance, and in the case of a high temperature ambience where the temperature is higher than normal temperature, the cleaning process control unit 226 makes the flow channel resistance of the supply flow channel 216 greater than the reference resistance so as to reduce the flow rate of the cleaning liquid supplied to the cleaning liquid nozzles 208 to suppress the height of the cleaning liquid pillar 202. On the other hand, in the case of a low temperature ambience where the temperature is lower than normal temperature, the cleaning process control unit 226 makes the flow channel resistance of the supply flow channel 216 smaller than the reference resistance so as to raise the flow rate of the cleaning liquid supplied to the cleaning liquid nozzles 208 to push up the height of the cleaning liquid pillar 202.

In FIG. 10 described above, if the temperature measured by the temperature sensor 224 is higher than normal temperature (e.g., 40° C.), the viscosity of the cleaning liquid declines, so that the height of the cleaning liquid pillar 202 would increase from 1.5 mm at normal temperature to 1.7 mm if there were no compensation. Then, the cleaning process control unit 226 in the present embodiment controls the flow channel resistance adjustment unit 318 in such a manner that the flow channel resistance of the supply flow channel 216 becomes greater than the reference resistance, so as to reduce the flow rate of the cleaning liquid supplied to the cleaning liquid nozzles 208 to keep the height of the cleaning liquid pillar 202 to the same value of 1.5 mm as in the case of normal temperature.

On the other hand, if the temperature measured by the temperature sensor 224 is lower than normal temperature (e.g., 5° C.), the viscosity of the cleaning liquid increases, so that the height of the cleaning liquid pillar 202 would decrease from 1.5 mm at normal temperature to 1.0 mm if there were no compensation. Then, the cleaning process control unit 226 controls the flow channel resistance adjustment unit 318 in such a manner that the flow channel resistance of the supply flow channel 216 becomes smaller than the reference resistance, so as to raise the flow rate of the cleaning liquid supplied to the cleaning liquid nozzles 208 to keep the height of the cleaning liquid pillar 202 to the same value of 1.5 mm as in the case of normal temperature.

If the temperature measured by the temperature sensor 224 is normal temperature, the cleaning process control unit 226 does not make change in the flow channel resistance adjustment unit 318 and the prevailing state is maintained.

The composition of the flow channel resistance adjustment unit 318 according to embodiments of the present invention is described below.

### First Embodiment of Flow Channel Resistance Adjustment Unit

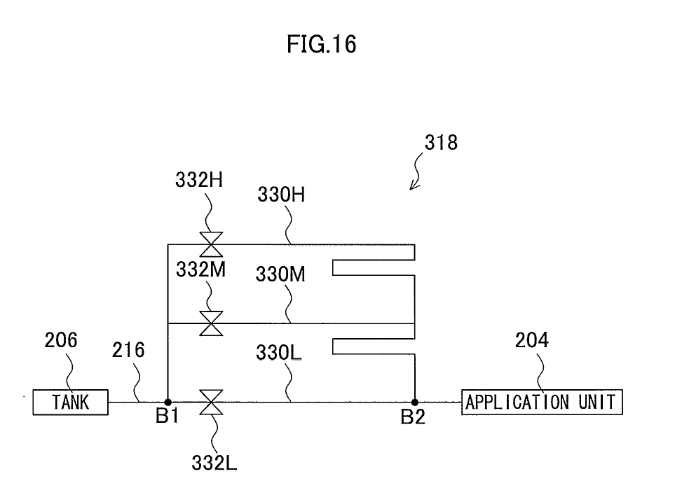

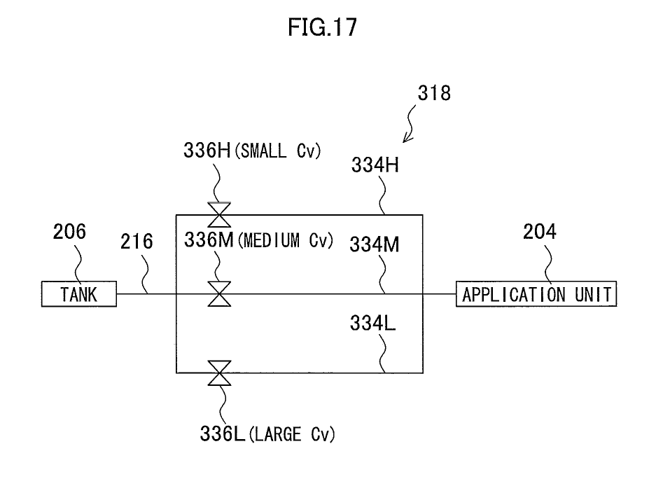

FIG. 16 is a schematic drawing showing a first embodiment of the composition of the flow channel resistance adjustment unit 318.

As shown in FIG. 16, the first embodiment of the composition of the flow channel resistance adjustment unit 318 includes: a high-temperature flow channel 330H, a normal-temperature flow channel 330M and a low-temperature flow channel 330L, which have mutually different lengths and are connected in parallel to the supply flow channel 216; and a high-temperature electromagnetic valve 332H, a normal-temperature electromagnetic valve 332M and a low-temperature electromagnetic valve 332L, which are arranged respectively in the flow channels 330H, 330M and 330L.

The flow channels 330H, 330M and 330L can be constituted respectively of dedicated flow channels, or may have a composition in which a portion of the flow channels is shared. FIG. 16 shows one example of a composition where the high-temperature flow channel 330H and the normal-temperature flow channel 330M share a portion of the flow channel

The flow channel length between a first connection point B1 and a second connection point B2, where the ends of the flow channels 330H, 330M and 330L are connected, becomes shorter progressively from the high-temperature flow channel 330H, to the normal-temperature flow channel 330M, to the low-temperature flow channel 330L.

The high-temperature flow channel 330H has the longest length from the first connection point B1 to the second connection point B2, hence applies the largest flow channel resistance to the supply flow channel 216 among the flow channels 330H, 330M and 330L, and is the flow channel used in a high temperature ambience.

The low-temperature flow channel 330L has the shortest length from the first connection point B1 to the second connection point B2, hence applies the smallest flow channel resistance to the supply flow channel 216 among the flow channels 330H, 330M and 330L, and is the flow channel used in a low temperature ambience.

The normal-temperature flow channel 330M has the length from the first connection point B1 to the second connection point B2 that is shorter than the flow channel 330H and longer than the flow channel 330L (and desirably, the middle of the lengths of the flow channel 330H and the flow channel 330L), and hence applies to the supply flow channel 216 the flow channel resistance that is smaller than the high-temperature flow channel 330H and greater than the low-temperature flow channel 330L (and desirably, the middle of the flow channel resistances of the flow channels 330H and 330L), and is the flow channel used in a normal temperature ambience.

The electromagnetic valves 332H, 332M and 332L are valve devices capable of opening and closing the respectively corresponding flow channels (flow channel opening and closing devices), in such a manner that the cleaning liquid flows from the cleaning liquid tank 206 to the cleaning liquid application unit 204 through the corresponding flow channel when the valve is open, and the flow of the cleaning liquid through the corresponding flow channel is shut off when the valve is closed. The opening and closing of the electromagnetic valves 332H, 332M and 332L are controlled by the cleaning process control unit 226 shown in FIG. 15.

The cleaning process control unit 226 controls the opening and closing of the electromagnetic valves 332H, 332M and 332L of the flow channel resistance adjustment unit 318 in accordance with the temperature measured by the temperature sensor 224.

More specifically, if the temperature measured by the temperature sensor 224 is normal temperature (normal temperature ambience), then the cleaning process control unit 226 opens the normal-temperature electromagnetic valve 332M only, of the electromagnetic valves 332H, 332M and 332L, in such a manner that the cleaning liquid is supplied from the cleaning liquid tank 206 to the cleaning liquid application unit 204 through the normal-temperature flow channel 330M.

If the temperature measured by the temperature sensor 224 is higher than normal temperature (a high temperature ambience), then the cleaning process control unit 226 opens the high-temperature electromagnetic valve 332H only, of the electromagnetic valves 332H, 332M and 332L, in such a manner that the cleaning liquid is supplied from the cleaning liquid tank 206 to the cleaning liquid application unit 204 through the high-temperature flow channel 330H. Thereby, the flow channel resistance of the supply flow channel 216 is made greater than the reference resistance in the case of normal temperature, and the flow rate of the cleaning liquid supplied to the cleaning liquid nozzles 208 is reduced, thereby making it possible to suppress the height of the cleaning liquid pillar 202.

On the other hand, if the temperature measured by the temperature sensor 224 is lower than normal temperature (a low temperature ambience), then the cleaning process control unit 226 opens the low-temperature electromagnetic valve 332L only, of the electromagnetic valves 332H, 332M and 332L, in such a manner that the cleaning liquid is supplied from the cleaning liquid tank 206 to the cleaning liquid application unit 204 through the low-temperature flow channel 330L. Thereby, the flow channel resistance of the supply flow channel 216 is made smaller than the reference resistance in the case of normal temperature, and the flow rate of the cleaning liquid supplied to the cleaning liquid nozzles 208 is raised, thereby making it possible to push up the height of the cleaning liquid pillar 202.

### Second Embodiment of Flow Channel Resistance Adjustment Unit

FIG. 17 is a schematic drawing showing a second embodiment of the composition of the flow channel resistance adjustment unit 318. In FIG. 17, members which are the same as or similar to those in FIG. 16 are denoted with the same reference numerals and description thereof is omitted here.

As shown in FIG. 17, the second embodiment of the composition of the flow channel resistance adjustment unit 318 includes: a high-temperature flow channel 334H, a normal-temperature flow channel 334M and a low-temperature flow channel 334L, which are connected in parallel to the supply flow channel 216; and a high-temperature electromagnetic valve 336H, a normal-temperature electromagnetic valve 336M and a low-temperature electromagnetic valve 336L, which have mutually different Cv values and are arranged respectively in the flow channels 334H, 334M and 334L.

It is possible that the lengths of all the flow channels 334H, 334M and 334L are the same, or the lengths of some of the flow channels are mutually different. In the latter case, it is desirable that the difference in the lengths of the flow channels 334H, 334M and 334L should be taken into account in setting the Cv values of the electromagnetic valves 336H, 336M and 336L described below, or the thicknesses (cross-sectional areas) of the flow channels 334H, 334M and 334L.

The electromagnetic valves 336H, 336M and 336L are flow channel opening and closing devices capable of opening and closing the respectively corresponding flow channels. In the present embodiment, the Cv values of the electromagnetic valves 336H, 336M and 336L are mutually different and the Cv value increases sequentially, from the high-temperature electromagnetic valve 336H, to the medium-temperature electromagnetic valve 336M, to the low-temperature electromagnetic valve 336L. The Cv value of the electromagnetic valve indicates the capacity of the valve, the flow volume becoming larger (i.e., the flow channel resistance becoming smaller), the greater the Cv value. The opening and closing of the electromagnetic valves 336H, 336M and 336L are controlled by the cleaning process control unit 226 shown in FIG. 15. The method of control implemented by the cleaning process control unit 226 is similar to that of the first embodiment of the composition of the flow channel resistance adjustment unit 318, and description thereof is omitted here.

### Third Embodiment of Flow Channel Resistance Adjustment Unit>

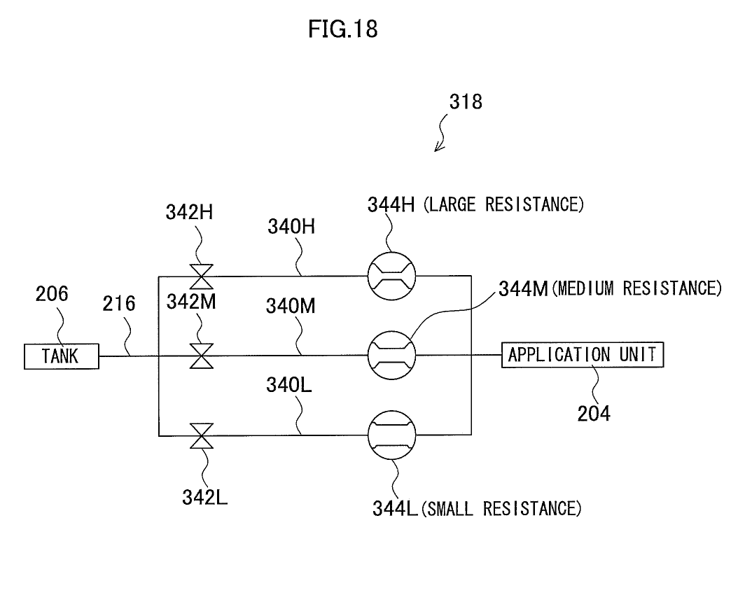

FIG. 18 is a schematic drawing showing a third embodiment of the composition of the flow channel resistance adjustment unit 318. In FIG. 18, members which are the same as or similar to those in FIG. 16 are denoted with the same reference numerals and description thereof is omitted here.

As shown in FIG. 18, the third embodiment of the composition of the flow channel resistance adjustment unit 318 includes: a high-temperature flow channel 340H, a normal-temperature flow channel 340M and a low-temperature flow channel 340L, which are connected in parallel to the supply flow channel 216; a high-temperature electromagnetic valve 342H, a normal-temperature electromagnetic valve 342M and a low-temperature electromagnetic valve 342L, which are arranged respectively in the flow channels 340H, 340M and 340L; and a high-temperature restrictor 344H, a normal-temperature restrictor 344M and a low-temperature restrictor 344L, which have mutually different flow channel cross-sectional areas and are arranged respectively in the flow channels 340H, 340M and 340L. The flow channel cross-sectional areas of the restrictors 344H, 344M and 344L increase successively from the high-temperature restrictor 344H, to the normal-temperature restrictor 344M, to the low-temperature restrictor 344L.

It is possible that the lengths of all the flow channels 340H, 340M and 340L are the same, or the lengths of some of the flow channels are mutually different. In the latter case, it is desirable that the difference in the lengths of the flow channels 340H, 340M and 340L should be taken into account in setting the sizes (flow channel cross-sectional areas) of the restrictors 344H, 344M and 344L.

It is possible that the Cv values of all of the electromagnetic valves 342H, 342M and 342L are the same, or the Cv values of some of the electromagnetic valves are mutually different. In the latter case, it is desirable that the difference in the Cv values of the electromagnetic valves 342H, 342M and 342L should be taken into account in setting the sizes (flow channel cross-sectional areas) of the restrictors 344H, 344M and 344L.

The electromagnetic valves 342H, 342M and 342L are flow channel opening and closing devices capable of opening and closing the respectively corresponding flow channels. The opening and closing of the electromagnetic valves 342H, 342M and 342L are controlled by the cleaning process control unit 226 shown in FIG. 15. The method of control implemented by the cleaning process control unit 226 is similar to that of the first embodiment of the composition of the flow channel resistance adjustment unit 318, and description thereof is omitted here.

### Fourth Embodiment of Flow Channel Resistance Adjustment Unit

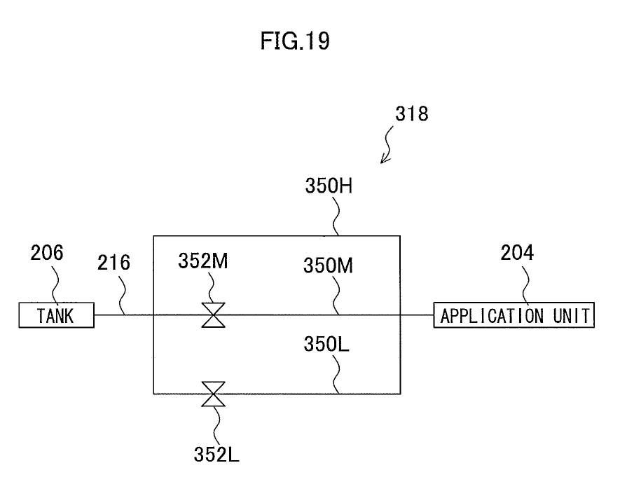

FIG. 19 is a schematic drawing showing a fourth embodiment of the composition of the flow channel resistance adjustment unit 318. In FIG. 19, members which are the same as or similar to those in FIG. 16 are denoted with the same reference numerals and description thereof is omitted here.

As shown in FIG. 19, the second embodiment of the composition of the flow channel resistance adjustment unit 318 includes: a high-temperature flow channel 350H, a normal-temperature flow channel 350M and a low-temperature flow channel 350L, which are connected in parallel to the supply flow channel 216; and a normal-temperature electromagnetic valve 352M and a low-temperature electromagnetic valve 352L, which are arranged respectively in the flow channels 350M and 350L apart from the high-temperature flow channel 350H. In other words, no electromagnetic valve is arranged in the high-temperature flow channel 350H, and the high-temperature flow channel 350H is always selected regardless of the temperature measured by the temperature sensor 224, in such a manner that the cleaning liquid is always supplied from the cleaning liquid tank 206 to the cleaning liquid application unit 204 through the high-temperature flow channel 350H at the least.

It is possible that the lengths of all the flow channels 350H, 350M and 350L are the same, or the lengths of some of the flow channels are mutually different. In the latter case, it is desirable that the difference in the lengths of the flow channels 350H, 350M and 350L should be taken into account in setting the thicknesses (cross-sectional areas) of the flow channels 350H, 350M and 350L.

Furthermore, the Cv values of the electromagnetic valves 352M and 352L can be the same or different. In the latter case, it is desirable that the difference in the Cv values of the electromagnetic valves 352M and 352L should be taken into account in setting the lengths and thicknesses of the flow channels 350H, 350M and 350L.

The electromagnetic valves 352M and 352L are flow channel opening and closing devices capable of opening and closing the respectively corresponding flow channels. The opening and closing of the electromagnetic valves 352M and 352L are controlled by the cleaning process control unit 226 shown in FIG. 15.

The cleaning process control unit 226 controls the opening and closing of the electromagnetic valves 352M and 352L of the flow channel resistance adjustment unit 318 in accordance with the temperature measured by the temperature sensor 224.

More specifically, if the temperature measured by the temperature sensor 224 is higher than normal temperature (a high temperature ambience), then the cleaning process control unit 226 opens both the electromagnetic valves 352M and 352L, in such a manner that the cleaning liquid is supplied from the cleaning liquid tank 206 to the cleaning liquid application unit 204 through the high-temperature flow channel 350H only.

If the temperature measured by the temperature sensor 224 is normal temperature (a normal temperature ambience), then the cleaning process control unit 226 opens the normal-temperature electromagnetic valve 352M only, of the electromagnetic valves 352M and 352L, in such a manner that the cleaning liquid is supplied from the cleaning liquid tank 206 to the cleaning liquid application unit 204 through the normal-temperature flow channel 350M, in addition to the high-temperature flow channel 350H, thereby increasing the supplied amount of the cleaning liquid compared to the high temperature ambience.

If the temperature measured by the temperature sensor 224 is lower than normal temperature (a low temperature ambience), then the cleaning process control unit 226 opens both the normal-temperature electromagnetic valve 352M and the low-temperature electromagnetic valve 352L, in such a manner that the cleaning liquid is supplied from the cleaning liquid tank 206 to the cleaning liquid application unit 204 through the normal-temperature flow channel 350M and the low-temperature electromagnetic valve 350L, in addition to the high-temperature flow channel 350H, thereby increasing the supplied amount of the cleaning liquid compared to the normal temperature ambience.

Thus, in the fourth embodiment of the composition of the flow channel resistance adjustment unit 318, the cleaning process control unit 226 controls the combination of opening and closing of the electromagnetic valves 352M and 352L arranged respectively in the normal-temperature flow channel 350M and the low-temperature flow channel 350L, of the plurality of flow channels 350H, 350M and 350L connected in parallel to the supply flow channel 216, so as to increase the amount of the cleaning liquid supplied from the cleaning liquid tank 206 to the cleaning liquid application unit 204 sequentially, from the high temperature ambience, to the normal temperature ambience, to the low temperature ambience. In other words, since the flow channels 350H, 350M and 350L are connected in parallel to the supply flow channel 216, then the flow channel resistance of the supply flow channel 216 becomes smaller in sequence, from the high temperature ambience, to the normal temperature ambience, to the low temperature ambience. Consequently, similarly to the first to third embodiments of the composition of the flow channel resistance adjustment unit 318 described above, the flow channel resistance of the supply flow channel 216 can be changed in accordance with the ambient temperature, it is hence possible to suppress the variation in the flow rate of the cleaning liquid supplied to the cleaning liquid nozzles 208 caused by the variation of the ambient temperature, and the height of the cleaning liquid pillar 202 produced on the cleaning liquid spouting surface 204A of the cleaning liquid application unit 204 can be made uniform without being affected by variation in the ambient temperature.

In the present sixth embodiment of the invention, by changing the flow channel resistance of the supply flow channel 216 in accordance with the ambient temperature around the cleaning processing unit 200 (and desirably, the temperature of the cleaning liquid in the cleaning liquid tank 206), it is possible to suppress the variation in the flow rate of the cleaning liquid supplied to the cleaning liquid nozzles 208 caused by the variation of the ambient temperature, and the height of the cleaning liquid pillar 202 produced on the cleaning liquid spouting surface 204A of the cleaning liquid application unit 204 can be made uniform irrespective of variation in the ambient temperature.

In the sixth embodiment, the temperature range of the ambient temperature is divided into three stages (the low temperature ambience, the normal temperature ambience and the high temperature ambience); however, the present invention is not limited to this, and the ambient temperature may also be divided into a greater number of stages, in such a manner that the flow channel resistance of the supply flow channel 216 is changed for each temperature range.

Furthermore, in the sixth embodiment, the embodiments of the composition of the flow channel resistance adjustment unit 318 have been described in which at least a portion of flow channels is selected from a plurality of flow channels (parallel flow channels) connected in parallel to the supply flow channel 216; however, the present invention is not limited to this, and it is also possible that the supply flow channel 216 is provided with, for example, a flow rate control valve capable of altering the degree of opening of the flow channel (the flow channel cross-sectional area) in stepwise, in such a manner that the flow channel resistance of the supply flow channel 216 can be changed by controlling the flow rate control valve in accordance with the ambient temperature. Moreover, it is also possible to change the flow channel resistance by altering the cross-sectional area of the supply flow channel 216 by means of an elastic film. According to these modes, it is possible to control the flow channel resistance of the supply flow channel 216 with good accuracy.

On the other hand, according to the first to fourth embodiments of the composition of the flow channel resistance adjustment unit 318 described above with reference to FIGS. 16 to 19, it is possible readily to control the flow channel resistance of the supply flow channel 216 by selecting one or more of flow channels from the flow channels connected in parallel to the supply flow channel 216, and hence the composition is simple and such modes are desirable from a cost viewpoint.

Furthermore, a desirable mode of the sixth embodiment is one including a device that adjusts the temperature of the cleaning liquid in the cleaning liquid tank 206 (a cleaning liquid temperature adjustment device).

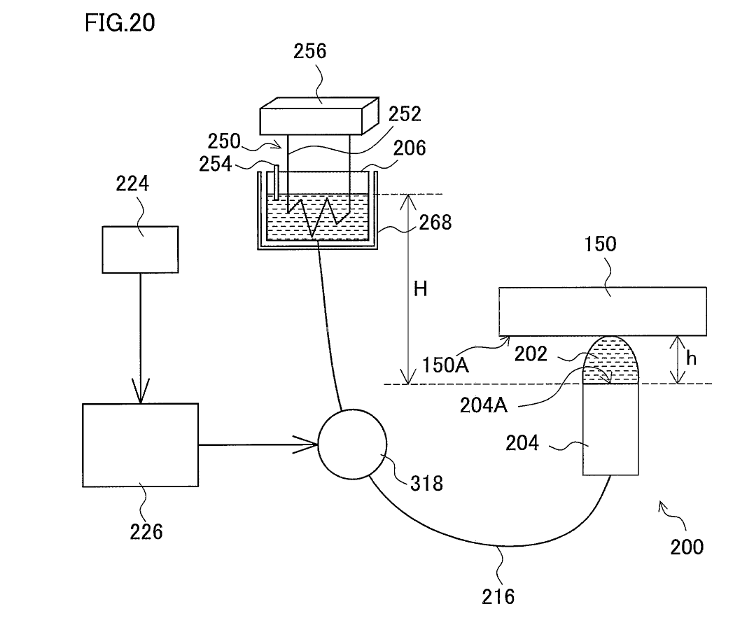

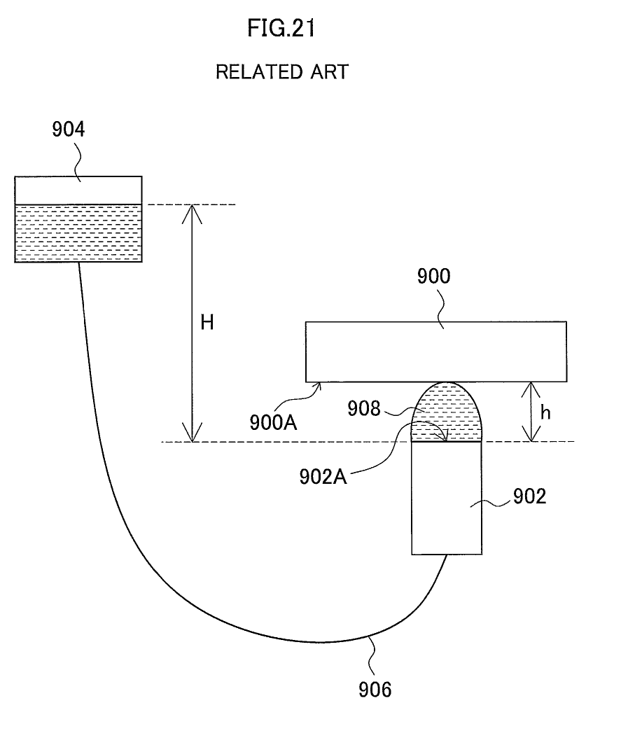

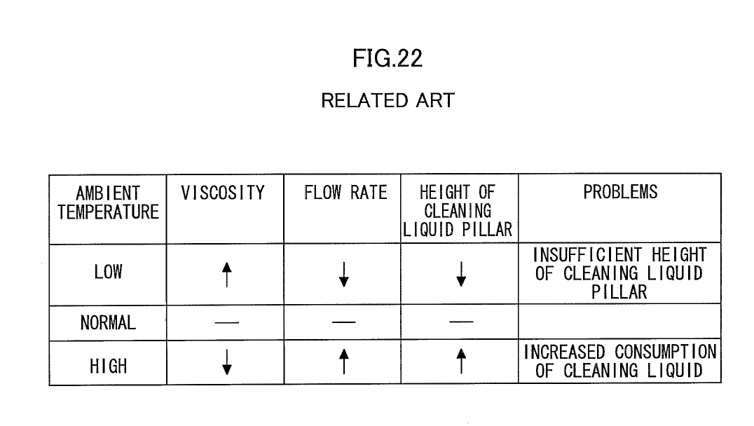

FIG. 20 is a schematic drawing showing a mode where a cleaning liquid temperature adjustment device is arranged in the cleaning liquid tank 206. In FIG. 20, members which are the same as or similar to those in FIGS. 14 and 15 are denoted with the same reference numerals and description thereof is omitted here.

It is desirable that the specific composition of the flow channel resistance adjustment unit 318 arranged in the supply flow channel 216 employs one of the first to fourth embodiments of the composition of the flow channel resistance adjustment unit 318 described above with reference to FIGS. 16 to 19.

According to the mode shown in FIG. 20, control is implemented in such a manner that the temperature of the cleaning liquid in the cleaning liquid tank 206 is kept uniform by the cleaning liquid temperature adjustment device 250, and therefore it is possible to reliably suppress the variation in the flow rate of the cleaning liquid supplied to the cleaning liquid nozzles 208, and the application of the cleaning liquid to the nozzle surface 150A of the head 150 can be made even more stable.

In the present embodiments, the modes have been described in which the cleaning processing unit 200 is appended to the inkjet recording apparatus 10; however, it is also possible to compose a cleaning apparatus for the inkjet head by separating the cleaning processing unit 200 from the inkjet recording apparatus 10.

Furthermore, in the present embodiments, the inkjet recording apparatus has been described which records a color image by ejecting and depositing color inks onto a recording medium as one example of an image formation apparatus; however, the present invention can also be applied to an image formation apparatus which forms a prescribed pattern shape on a substrate by means of a resin liquid, or the like, in order, for instance, to form a mask pattern or to print wiring of a printed wiring board.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A liquid ejection head cleaning apparatus, comprising:
a cleaning liquid deposition device which spouts cleaning liquid from a plurality of cleaning liquid nozzles and deposits the cleaning liquid onto an ejection surface of a liquid ejection head;
a cleaning liquid supply device which supplies the cleaning liquid to the cleaning liquid nozzles by using a liquid head differential with respect to the cleaning liquid deposition device;
a temperature measurement device which measures an ambient temperature around the cleaning liquid supply device; and
a pressure control device which controls a pressure of the cleaning liquid supplied to the cleaning liquid deposition device from the cleaning liquid supply device in accordance with the ambient temperature measured by the temperature measurement device.

2. The apparatus as defined in claim 1, further comprising:
a pressure adjustment device which adjusts a pressure inside the cleaning liquid supply device,
wherein the pressure control device changes the pressure inside the cleaning liquid supply device by controlling the pressure adjustment device in accordance with the ambient temperature measured by the temperature measurement device.

3. The apparatus as defined in claim 1, further comprising:
an elevator device which changes a height of the cleaning liquid supply device with respect to the cleaning liquid deposition device,
wherein the pressure control device changes the height of the cleaning liquid supply device by controlling the elevator device in accordance with the ambient temperature measured by the temperature measurement device.

4. The apparatus as defined in claim 1, further comprising:
a liquid surface height adjustment device which adjusts a height of a surface of the cleaning liquid inside the cleaning liquid supply device,
wherein the pressure control device changes the height of the surface of the cleaning liquid inside the cleaning liquid supply device by controlling the liquid surface height adjustment device in accordance with the ambient temperature measured by the temperature measurement device.

5. The apparatus as defined in claim 1, further comprising:
a supply flow channel which connects the cleaning liquid supply device to the cleaning liquid deposition device; and
a flow channel resistance adjustment device which adjusts a flow channel resistance of the supply flow channel,
wherein the pressure control device changes the flow channel resistance of the supply flow channel by controlling the flow channel resistance adjustment device in accordance with the ambient temperature measured by the temperature measurement device.

6. The apparatus as defined in claim 5, wherein:
the flow channel resistance adjustment device includes: a plurality of parallel flow channels connected in parallel to the supply flow channel; and a flow channel selecting device which selects at least one of the parallel flow channels; and
the pressure control device controls the flow channel selecting device in accordance with the ambient temperature measured by the temperature measurement device.

7. The apparatus as defined in claim 6, wherein:
at least one of the parallel flow channels has a valve device to open and close the at least one of the parallel flow channels; and
the pressure control device selects at least one of the parallel flow channels by controlling the valve device in accordance with the ambient temperature measured by the temperature measurement device.

8. The apparatus as defined in claim 7, wherein the parallel flow channels have mutually different lengths.

9. The apparatus as defined in claim 7, wherein the parallel flow channels have restrictor sections, respectively, the restrictor sections having mutually different flow channel cross-sectional areas.

10. The apparatus as defined in claim 7, wherein the pressure control device always selects, apart from the at least one of the parallel flow channels having the valve device, another of the parallel flow channels, and additionally selects the at least one of the parallel flow channels having the valve device by controlling the valve device in accordance with the ambient temperature measured by the temperature measurement device.

11. The apparatus as defined in claim 6, wherein:
at least two of the parallel flow channels have valve devices to open and close respectively the at least two of the parallel flow channels, the valve devices having mutually different Cv values; and
the pressure control device selects at least one of the parallel flow channels by controlling the valve device in accordance with the ambient temperature measured by the temperature measurement device.

12. The apparatus as defined in claim 1, further comprising a cleaning liquid temperature adjustment device which adjusts a temperature of the cleaning liquid in the cleaning liquid supply device.

13. The apparatus as defined in claim 1, wherein the cleaning liquid deposition device includes a flow rate adjustment device which adjusts a flow rate of the cleaning liquid supplied to each of the cleaning liquid nozzles in such a manner that heights of the cleaning liquid spouted from the cleaning liquid nozzles are uniform.

14. The apparatus as defined in claim 13, wherein:
the cleaning liquid deposition device includes the cleaning liquid nozzles arranged along a prescribed alignment direction and has a flow channel connecting to the cleaning liquid nozzles; and
the flow channel has a restrictor having a width less than a diameter of each of the cleaning liquid nozzles.

15. The apparatus as defined in claim 14, wherein the restrictor includes a groove formed along the alignment direction of the cleaning liquid nozzles.

16. The apparatus as defined in claim 13, wherein:
the cleaning liquid deposition device has an inlet port through which the cleaning liquid is introduced from the cleaning liquid supply device;
a first flow channel resistance from the inlet port to the cleaning liquid nozzles arranged in a first region is larger than a second flow channel resistance from the inlet port to the cleaning liquid nozzles arranged in a second region; and
a first interval between the cleaning liquid nozzles arranged in the first region is smaller than a second interval between the cleaning liquid nozzles arranged in the second region.

17. The apparatus as defined in claim 1, further comprising:
a movement device which causes the liquid ejection head and the cleaning liquid deposition device to move relatively to each other,
wherein the cleaning liquid deposition device includes the cleaning liquid nozzles arranged through a length not shorter than a breadth of the liquid ejection head.

18. An image recording apparatus, comprising:
a liquid ejection head having an ejection surface in which a plurality of nozzles to eject liquid are arranged; and
a liquid ejection head cleaning device which deposits cleaning liquid onto the ejection surface of the liquid ejection head, the liquid ejection head cleaning device including:
a cleaning liquid deposition device which spouts the cleaning liquid from a plurality of cleaning liquid nozzles and deposits the cleaning liquid onto the ejection surface of the liquid ejection head;
a cleaning liquid supply device which supplies the cleaning liquid to the cleaning liquid nozzles by using a liquid head differential with respect to the cleaning liquid deposition device;
a temperature measurement device which measures an ambient temperature around the cleaning liquid supply device; and
a pressure control device which controls a pressure of the cleaning liquid supplied to the cleaning liquid deposition device from the cleaning liquid supply device in accordance with the ambient temperature measured by the temperature measurement device.

19. The apparatus as defined in claim 18, wherein:
the liquid ejection head cleaning device further includes a pressure adjustment device which adjusts a pressure inside the cleaning liquid supply device; and
the pressure control device changes the pressure inside the cleaning liquid supply device by controlling the pressure adjustment device in accordance with the ambient temperature measured by the temperature measurement device.

20. The apparatus as defined in claim 18, wherein:
the liquid ejection head cleaning device further includes an elevator device which changes a height of the cleaning liquid supply device with respect to the cleaning liquid deposition device; and
the pressure control device changes the height of the cleaning liquid supply device by controlling the elevator device in accordance with the ambient temperature measured by the temperature measurement device.

21. The apparatus as defined in claim 18, wherein:
the liquid ejection head cleaning device further includes a liquid surface height adjustment device which adjusts a height of a surface of the cleaning liquid inside the cleaning liquid supply device; and
the pressure control device changes the height of the surface of the cleaning liquid inside the cleaning liquid supply device by controlling the liquid surface height adjustment device in accordance with the ambient temperature measured by the temperature measurement device.

22. The apparatus as defined in claim 18, wherein:
the liquid ejection head cleaning device further includes: a supply flow channel which connects the cleaning liquid supply device to the cleaning liquid deposition device; and a flow channel resistance adjustment device which adjusts a flow channel resistance of the supply flow channel; and
the pressure control device changes the flow channel resistance of the supply flow channel by controlling the flow channel resistance adjustment device in accordance with the ambient temperature measured by the temperature measurement device.
